(19) United States
(12) Patent Application Publication
(10) Pub. No.: US 2017/0158984 A1
(43) Pub. Date: Jun. 8, 2017

(54) METHOD FOR DEGUMMING COMPOSITIONS CONTAINING TRIGLYCERIDE

(71) Applicant: CLARIANT PRODUKTE (DEUTSCHLAND) GMBH, Frankfurt am Main (DE)

(72) Inventors: Ulrich SOHLING, Freising (DE); Kirstin SUCK, München (DE); Karin RAUCH, Moosburg (DE); Marion ROSSBAUER, Nandlstadt (DE)

(21) Appl. No.: 15/318,514

(22) PCT Filed: Jun. 17, 2015
(86) PCT No.: PCT/EP2015/063584

§ 371 Date: Dec. 13, 2016

(30) Foreign Application Priority Data
Jun. 17, 2014 (EP) 14002085.0

(51) Int. Cl. C11B 3/00

(52) U.S. Cl. CPC C11B 3/006; C11B 3/003

(57) ABSTRACT

The present invention relates to a method for degumming compositions containing triglyceride with addition of a solubilizer, and to a composition containing triglyceride which has been degummed by the method according to the invention.

The present invention relates to a method of degumming triglyceride-containing compositions with addition of a solubilizer, and to a triglyceride-containing composition which has been degummed by the method of the invention.

On account of the worldwide increase in the consumption of edible oil and the ever increasing use of vegetable oils as raw materials for the chemical industry and as a fuel, there is a constant further need to improve the degumming of triglyceride-containing compositions, in particular of vegetable oils and/or vegetable oil gums.

Triglycerides, which are obtained from vegetable raw materials, in particular crude vegetable oils, contain phosphatides, protein- and carbohydrate-containing substances, vegetable gums and also colloidal compounds, which reduce the life of the oil considerably and lower the yield of the purified oil. These substances must therefore be removed.

In the refining of vegetable oils, these undesirable accompanying substances are removed. A distinction is made between chemical and physical refining. Chemical refining consists of the processes of 1. degumming, in which phospholipids and metal ions are removed from the oil, 2. neutralization with alkali, in which the fatty acids are extracted, 3. bleaching to remove dyes, further metal ions and residual gums, 4. deodorization, a steam distillation, in which further compounds which impair the odor and taste of the oil are removed. In physical refining, the deacidification is carried out together with the deodorization at the end of the refining process.

The degumming of the oils can be effected by extracting the phospholipids with water or an aqueous solution of an acid that complexes Ca²⁺ and Mg²⁺ ions, for example citric acid or phosphoric acid. In this case, first of all, an aqueous degumming operation, called pre-degumming, is conducted, by means of which the water-soluble phospholipids are removed. These are referred to as hydratable phospholipids. Pre-degumming with water generally serves to produce lecithin.

U.S. Pat. No. 2,544,725 describes a method of aqueous degumming in which up to 10% of specific oil-soluble fatty acid esters of polyhydroxyl compounds are added to glyceride oil before the addition of water, in order to facilitate the subsequent removal of the water phase.

A disadvantage of the oil degumming processes of the prior art is that both aqueous pre-degumming and treatment with aqueous acids lead to oil losses, which arise because the phospholipids transferred into the water are emulsifiers which emulsify a portion of the vegetable oil in the aqueous phase, so that vegetable oil is lost. As a rule of thumb, with every two molecules of phospholipid, about one triglyceride molecule is emulsified. This leads to considerable financial losses when the methods mentioned are employed on the industrial scale.

On account of the worldwide increase in the consumption of edible oil and the ever increasing use of vegetable oils as a raw material for the chemical industry and as a fuel, there is a constant further need to improve the degumming of triglyceride-containing compositions, in particular of vegetable oils and/or vegetable oil gums.

The inventors of the present application have therefore set themselves the object of providing a method of degumming triglyceride-containing compositions, in particular crude or pre-degummed vegetable oils, with which the phosphorus content of the triglyceride-containing composition can be reduced further, the oil yield can be increased and the reaction rate of the degumming can be increased. At the same time, it is to be possible to carry out this method economically on an industrial scale.

It has now been found, surprisingly, that the object according to the invention can be achieved by a method comprising the steps
(a) contacting a triglyceride-containing composition with at least one solubilizer;
(b) separating the gum phase from the triglyceride-containing composition.

Within the scope of the present invention, the term “triglyceride” is understood to mean any triester of glycerol with fatty acids, whether of vegetable or animal origin. Triglyceride-containing compositions for the purposes of the present invention include vegetable or animal fats and oils and mixtures thereof both with one another and with synthetic or modified fats and oils. According to the present invention, a triglyceride-containing composition may also contain, in addition to the triglycerides defined within the scope of the present application, a proportion of water and/or acid which is chosen preferably in the range from 0.001 to 50% by weight, more preferably in the range from 0.01 to 20% by weight, in particular in the range from 0.1 to 10% by weight and most preferably in the range from 0.5 to 5% by weight.

Within the scope of the present invention, the expression “vegetable oil” is understood to mean any oil of vegetable origin. Preferred, particularly suitable vegetable oils are soybean oil, rapeseed oil, canola oil, sunflower oil, olive oil, palm oil, jatropha oil, camelina oil, cottonseed oil, groundnut oil and mixtures thereof. “Crude vegetable oils” are particularly suitable. The term “crude” refers to the fact that the oil has not yet undergone any degumming, neutralizing, bleaching, deodorizing and/or pre-conditioning step. The expressions “crude vegetable oil” and “crude oil” are used synonymously within the scope of the present invention. It is also possible within the scope of the method of the invention for a mixture of a plurality of crude oils and/or pre-degummed and/or pre-conditioned oils in a mixture to be used as the triglyceride-containing composition.

Within the scope of the present invention, “gum phase”, “gums” or “vegetable oil gum” is understood to mean all substances which are obtained from crude vegetable oils as the heavy phase after treatment with water and/or acid and/or alkali. The expressions “gum phase”, “gums”, “vegetable oil gum” are used synonymously within the scope of the present invention. The use of this gum phase is advantageous, for example, as the starting material for obtaining lecithin, because lecithin is a substantial constituent of vegetable oil gum.

The term “degumming” is understood to mean the separation of the above-mentioned substances (“gum phase”, “gums”, “vegetable oil gum”).

Within the scope of the present invention, the expression “pre-degumming” or “wet degumming” is understood to mean the treatment of a crude oil with water and/or acid in order to remove water-soluble phospholipids from the oil. The expressions “pre-degumming” and “wet degumming” are used synonymously within the scope of the present invention. It is also possible, within the scope of pre-degumming or wet degumming with acid or an aqueous acid, for alkali or an aqueous alkali to be added after the addition of the acid in order to neutralize the acid. Before further treatment of the pre-degummed oil with a solubilizer and optionally an enzyme, the aqueous phase is removed. By means of pre-degumming, the phosphorus content in the extracted crude oil is reduced from approximately 500 to 1500 ppm, for example for soya and rape, to less than 200 ppm in the pre-degummed oil. Lecithin, for example, can be obtained from the resulting gum phase, or the gum phase can be reprocessed as animal feed. However, the disadvantage of removing the aqueous phase, or lowering the phosphorus content, is a loss of yield in respect of the oil. The phosphatides transferred into the aqueous phase have an emulsifying action and result in a portion of the oil being emulsified in the aqueous phase and removed therewith.

Within the scope of the present invention, the expression “pre-degummed oil” or “pre-degummed vegetable oil” is understood to mean a crude oil which has been subjected to the process of “pre-degumming” defined above. All the expressions (“pre-degummed oil” and “pre-degummed vegetable oil”) are used synonymously within the scope of the present invention.

Within the scope of the present invention, the term “pre-conditioning” of the triglyceride-containing composition is understood to mean the addition of water and/or acid and/or alkali to the triglyceride-containing composition. The amount of water and/or acid and/or alkali is chosen preferably in the range from 0.001 to 80% by weight, more preferably in the range from 0.01 to 65% by weight, in particular in the range from 0.1 to 50% by weight and most preferably in the range from 5 to 40% by weight. However, the aqueous phase is not subsequently removed; instead, the pre-conditioned triglyceride-containing composition is subjected directly to further steps, such as contacting with a solubilizer.

Within the scope of the present invention, the expression “solubilizer” or “solubilizing agent” is understood to mean any substance which, by its presence, contributes towards the dissolution of sparingly soluble substances in a solvent. The two expressions (“solubilizer” and “solubilizing agent”) are used synonymously within the scope of the present invention. Preferred solubilizers within the scope of the present invention are selected from the group of the emulsifiers and co-emulsifiers and have an HLB value of from 5.5 to 13.5, preferably from 6 to 12 and more preferably from 7.5 to 10.5.

The HLB value (hydrophilic-lipophilic balance) in chemistry describes the hydrophilic and lipophilic portion of mainly non-ionic surfactants. Within the scope of the present invention, the term “HLB value” is understood to mean the HLB value according to Griffin.

Within the scope of the present invention, preferred solubilizers are selected from the group consisting of polyhydroxyl compounds, polyglycols, alcohols and mixtures thereof. If the at least one solubilizer is an alcohol, it is preferably selected from the group consisting of methanol, ethanol, butanol and mixtures thereof. It is further preferred within the scope of the method of the invention that the polyhydroxyl compounds used as solubilizer have an asymmetric molecular structure. Within the scope of the present invention, particular preference is given to polyhydroxyl compounds selected from the group consisting of propane-1,2-diol, propane-1,3-diol, butane-1,2-diol, methylglycol, methylpropane-1,3-diol, sucrose esters, mono- and diacetyltartrates of monoglycerides, polyglycerol esters, sorbitan esters, polyoxyethylene sorbitan esters, polyethylene glycols, copolymers of ethylene oxide and propylene oxide units and mixtures thereof. Likewise preferred are solubilizers selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol, heptane-1,7-diol and mixtures thereof. Among the polyethylene glycols and the copolymers of ethylene oxide and propylene oxide units, preference is given to those which bear an alkyl group at one end. Propane-1,2-diol is particularly preferred within the scope of the present invention because it is inexpensive and is suitable for use in triglyceride-containing compositions that are used to produce foodstuffs, for example vegetable oils of the above-mentioned type.

The at least one solubilizer is used in concentrations of preferably from 0.005 to 10% by weight, more preferably from 0.01 to 5% by weight, even more preferably from 0.025 to 2% by weight, especially preferably less than from 0.03 to 1% by weight and most preferably from 0.075 to 3% by weight, based on the amount of oil.

Use of the at least one solubilizer having the above-described properties surprisingly leads, as compared with a comparable process without the use of the solubilizer, with different variants of the aqueous degumming, to a smaller amount of the oil emulsified in the aqueous phase and, associated therewith, to a higher oil yield and to a more rapid phase separation after completion of the degumming process. Furthermore, as compared with the comparable process without solubilizer, the contents of P, Ca²⁺, Mg²⁺ are reduced significantly. The process according to the invention has the advantage in respect of the oil mill that, in particular when using crude vegetable oil, a higher oil yield can be achieved as compared with a comparable process and the resulting oil has a lower content of impurities.

The addition of the at least one solubilizer further improves the economics of the oil degumming process as a whole, in that other additives can be used in smaller dosages. For example, in acidic degumming, the dosage of citric acid or phosphoric acid can be reduced further.

Propane-1,2-diol is particularly preferred for this reason, because it has good water solubility, and so the majority thereof remains in the aqueous degumming solution.

The at least one enzyme that is added to the triglyceride-containing composition before the gum phase is removed according to step (b) of the method of the invention is preferably a phospholipid-cleaving enzyme.

A “phospholipid-cleaving enzyme” may be a phospholipase which is capable of cleaving either a fatty acid residue or a phosphatidyl residue or an end group from a phospholipid. Examples are phospholipase A1, phospholipase A2, phospholipase C, phospholipase B, phospholipase D or mixtures of phospholipases. Furthermore, it may also be what is called an acyltransferase, where the cleavage of the fatty acid residue is combined with a transfer of that residue, followed by ester formation with a free sterol in the oil phase. Within the scope of the present invention, “phospholipid-cleaving” denotes any enzyme that has phospholipase activity and/or acyltransferase activity as the main or subsidiary activity.

Phospholipases are enzymes which belong to the group of the hydrolases and which hydrolyse the ester binding of phospholipids. Phospholipases are divided into 5 groups according to their regioselectivity in the case of phospholipids:

Phospholipases A1 (PLA1), which cleave the fatty acid in the sn1-position with formation of the 2-lysophospholipid.

Phospholipases A2 (PLA2), which cleave the fatty acid in the sn2-position with formation of the 1-lysophospholipid.

Phospholipases C (PLC), which cleave a phosphoric monoester.

Phospholipases D (PLD), which cleave or replace the end group.

Phospholipases B (PLB), which cleave the fatty acid both in the sn1-position and in the sn2-position with formation of a 1,2-lysophospholipid.

Within the scope of the present invention, an acyltransferase is understood as being an enzyme which transfers acyl groups, for example fatty acids, from a phospholipid to a suitable acceptor, for example a sterol, with formation of an ester.

In a further preferred embodiment, the at least one enzyme that is added to the composition before the gum phase is removed according to step (b) of the method of the invention is an enzyme selected from the group of the glycoside-cleaving enzymes. The enzyme from the group of the glycoside-cleaving enzymes can be used either on its own or in combination with one or more of the above-mentioned phospholipid-cleaving enzymes. The glycoside-cleaving enzyme is preferably selected from the group consisting of amylase, amyloglucosidase, laminaranase, glucoamylase, glucosidase, galactosidase, glucanase, mannanase, pectinase, cellulase, xylanase, pullulanase, arabinase, dextranase or and mixtures thereof.

The at least one enzyme may originate from any desired organism (e.g. can also be isolated from a thermophilic organism) or from a synthetic source. The at least one enzyme can be of animal origin, for example from the pancreas, of vegetable origin or of microbial origin, for example from yeast, fungi, algae or bacteria. It is also possible within the scope of the present invention that enzymes of the same type but which originate from different sources or species are used. Also included are chimeric fusion proteins produced by recombinant methods from two or more different species having enzymatic activity.

Within the scope of the present invention, phospholipase A1, phospholipase A2, phospholipase C, phospholipase B, phospholipase D, acyltransferase, glycoside-cleaving enzymes and mixtures thereof from the following species are preferably used: porcine pancreas, bovine pancreas, snake venom, bee venom, Aspergillus, Bacillus, Citrobacter, Clostridium, Dictyostelium, Edwardsiella, Enterobacter, Escherichia, Erwinia, Fusarium, Klebsiella, Listeria, Mucor, Naja, Neurospora, Pichia, Proteus, Pseudomonas, Providencia, Rhizomucor, Rhizopus, Salmonella, Sclerotinia, Serratia, Shigella, Streptomyces, Thermomyces, Trichoderma, Trichophyton, Whetzelinia, Yersinia.

Particular preference is given to the use of phospholipase A1, phospholipase A2, phospholipase C, phospholipase B, phospholipase D, acyltransferase and mixtures thereof from Aspergillus awamori, Aspergillus foetidus, Aspergillus fumigatus, Aspergillus japonicus, Aspergillus niger, Aspergillus oryzae, Bacillus alvei, Bacillus amyloliquefaciens, Bacillus anthracis, Bacillus atrophaeus, Bacillus cereus, Bacillus circulans, Bacillus coagulans, Bacillus larvae, Bacillus laterosporus, Bacillus megaterium, Bacillus natto, Bacillus pasteurii, Bacillus pumilus, Bacillus sphaericus, Bacillus sporothermodurans, Bacillus subtilis, Bacillus thuringiensis, Bacillus pseudoanthracis, Citrobacter amalonaticus, Citrobacter braakii, Citrobacter farmeri, Citrobacter freundii, Citrobacter gillenii, Citrobacter koseri, Citrobacter murliniae, Citrobacter rodentium, Citrobacter sedlakii, Citrobacter werkmanii, Citrobacter youngae, Clostridium perfringens, Dictyostelium discoideum, Dictyostelium mucoroides, Dictyostelium polycephalum, Edwardsiella hoshinae, Edwardsiella ictaluri, Edwardsiella tarda, Enterobacter amnigenus, Enterobacter aerogenes, Enterobacter cloacae, Enterobacter gergoviae, Enterobacter intermedius, Enterobacter pyrinus, Escherichia albertii, Escherichia blattae, Escherichia coli, Escherichia fergusonii, Escherichia hermannii, Escherichia senegalensis, Escherichia vulneris, Erwinia amylovora, Erwinia aphidicola, Erwinia billingiae, Erwinia carotovora, Erwinia herbicola, Erwinia oleae, Erwinia mallotivora, Erwinia papayae, Erwinia persicina, Erwinia piriflorinigrans, Erwinia psidii, Erwinia pyrifoliae, Erwinia rhapontici, Erwinia tasmaniensis, Erwinia toletana, Erwinia tracheiphila, Fusarium avenaceum, Fusarium avenaceum, Fusarium chlamydosporum, Fusarium coeruleum, Fusarium culmorum, Fusarium dimerum, Fusarium incarnatum, Fusarium heterosporum, Fusarium moniliforme, Fusarium napiforme, Fusarium oxysporum, Fusarium poae, Fusarium sporotrichiella, Fusarium tricinctum, Fusarium proliferatum, Fusarium sacchari, Fusarium solani, Fusarium sporotrichioides, Fusarium subglutinans, Fusarium tabacinum, Fusarium verticillioides, Klebsiella oxytoca, Klebsiella mobilis, Klebsiella singaporensis, Klebsiella granulomatis, Klebsiella pneumoniae, Klebsiella variicola, Listeria monocytogenes, Mucor amphibiorum, Mucor circinelloides, Mucor hiemalis, Mucor indicus, Mucor javanicus, Mucor mucedo, Mucor paronychius, Mucor piriformis, Mucor subtilissimus, Mucor racemosus, Naja mossambica, Neurospora Africana, Neurospora crassa, Neurospora discrete, Neurospora dodgei, Neurospora galapagosensis, Neurospora intermedia, Neurospora lineolata, Neurospora pannonica, Neurospora sitophila, Neurospora sublineolata, Neurospora terricola, Neurospora tetrasperma, Pichia barkeri, Pichia cactophila, Pichia cecembensis, Pichia cephalocereana, Pichia deserticola, Pichia eremophilia, Pichia exigua, Pichia fermentans, Pichia heedii, Pichia kluyveri, Pichia kudriavzevii, Pichia manshurica, Pichia membranifaciens, Pichia nakasei, Pichia norvegensis, Pichia orientalis, Pichia pastoris (Komagataella pastoris), Pichia pseudocactophila, Pichia scutulata, Pichia sporocuriosa, Pichia terricola, Proteus hauseri, Proteus mirabilis, Proteus myxofaciens, Proteus penneri, Proteus vulgaris, Pseudomonas aeruginosa, Pseudomonas fluorescens, Pseudomonas putida, Pseudomonas syringae, Providencia rettgeri, Providencia stuartii, Rhizomucor endophyticus, Rhizomucor miehei, Rhizomucor pakistanicus, Rhizomucor pusillus, Rhizomucor tauricus, Rhizomucor variabilis, Rhizopus arrhizus, Rhizopus azygosporus, Rhizopus circinans, Rhizopus japonicus, Rhizopus microsporus, Rhizopus nigricans, Rhizopus oligosporus, Rhizopus oryzae, Rhizopus schipperae, Rhizopus sexualis, Rhizopus stolonifer, Rhizopus artocarpi, Salmonella bongori, Salmonella enterica, Salmonella typhimurium, Sclerotinia borealis, Sclerotinia homoeocarpa, Sclerotinia libertiana, Sclerotinia minor, Sclerotinia ricini, Sclerotinia sclerotiorum, Sclerotinia spermophila, Sclerotinia trifoliorum, Serratia entomophila, Serratia ficaria, Serratia fonticola, Serratia grimesii, Serratia liquefaciens, Serratia marcescens, Serratia odorifera, Serratia plymuthica, Serratia proteamaculans, Serratia quinivorans, Serratia rubidaea, Serratia symbiotica, Shigella dysenteriae, Shigella flexneri, Shigella boydii, Shigella sonnei, Streptomyces achromogenes, Streptomyces ambofaciens, Streptomyces aureofaciens, Streptomyces avermitilis, Streptomyces carcinostaticus, Streptomyces cervinus, Streptomyces clavuligerus, Streptomyces coelicolor, Streptomyces coeruleorubidus, Streptomyces davawensis, Streptomyces fradiae, Streptomyces griseus, Streptomyces hygroscopicus, Streptomyces lavendulae, Streptomyces lincolnensis, Streptomyces natalensis, Streptomyces nodosus, Streptomyces noursei, Streptomyces peuceticus, Streptomyces platensis, Streptomyces rimosus, Streptomyces spectabilis, Streptomyces toxytricini, Streptomyces venezuelae, Streptomyces violaceoniger, Streptomyces violaceoruber, Thermomyces lanuginosa, Trichoderma harzianum, Trichoderma koningii, Trichoderma longibrachiatum, Trichoderma pseudokoningii, Trichoderma reesei, Trichoderma viride, Trichophyton concentricum, Trichophyton eboreum, Trichophyton equinum, Trichophyton gourvilii, Trichophyton kanei, Trichophyton megninii, Trichophyton mentagrophytes, Trichophyton phaseoliforme, Trichophyton raubitschekii, Trichophyton rubrum, Trichophyton schoenleinii, Trichophyton simii, Trichophyton soudanense, Trichophyton terrestre, Trichophyton tonsurans, Trichophyton vanbreuseghemii, Trichophyton verrucosum, Trichophyton violaceum, Trichophyton yaoundei, Whetzelinia sclerotiorum, Yersinia aldovae, Yersinia aleksiciae, Yersinia bercovieri, Yersinia enterocolitica, Yersinia frederiksenii, Yersinia intermedia, Yersinia kristensenii, Yersinia massiliensis, Yersinia mollaretii, Yersinia pestis, Yersinia pseudotuberculosis, Yersinia rohdei, Yersinia ruckeri, Yersinia similis.

In a particularly preferred embodiment, phospholipase A₁, phospholipase A₂, phospholipase B, phospholipase C and/or phospholipase D are used that originate from Aspergillus niger, Aspergillus oryzae, Bacillus cereus, Bacillus megaterium, Bacillus subtilis, Citrobacter freudii, Enterobacter aerogenes, Enterobacter cloacae, Edwardsiella tarda, Erwinia herbicola, Escherichia coli, Clostridium perfringens, Dictyostelium discoideum, Fusarium oxysporium, Klebsiella pneumoniae, Listeria monocytogenes, Mucor javanicus, Mucor mucedo, Mucor subtilissimus, Naja mossambica, Neurospora crassa, Pichia pastoris (Komagataella pastoris), Pseudomonas spezies, Proteus vulgaris, Providencia stuartii, Rhizomucor pusillus, Rhizopus arrhizus, Rhizopus japonicus, Rhizopus stolonifer, Salmonella typhimurium, Serratia marcescens, Serratia liquefaciens, Sclerotinia libertiana, Shigella flexneri, Streptomyces violaceoruber, Trichophyton rubrum, Thermomyces lanuginosus, Trichoderma reesei, Whetzelinia sclerotiorum, Yersinia enterocolitica, porcine pancreas, bovine pancreas, snake venom or bee venom.

The at least one enzyme may originate from the same source or from different sources, preferably from one or else from a plurality of the above-mentioned organisms, more preferably from Aspergillus niger, Aspergillus oryzae, Fusarium oxysporium, Naja mossambica, Pichia pastoris (Komagataella pastoris), Streptomyces violaceoruber, Thermomyces lanuginosus, Trichoderma reesei, porcine pancreas or bovine pancreas.

With regard to the glycoside-cleaving enzymes, preference is given to those which cleave α(1-4)glycosidic, α(1-2)glycosidic, α(1-6)glycosidic, β(1-3)glycosidic, β(1-4)glycosidic and/or β(1-6)glycosidic bonds.

Amylases, in particular α-amylases, β-amylases, γ-amylases and isoamylases, and also mannanases are also preferred.

With regard to the amylases, preference is given to those from Bacillus or Pseudomonas or fungal species or from pancreas, in particular those from Bacillus sp. such as Bacillus subtilis, Bacillus licheniformis, Bacillus megaterium, Bacillus amyloliquefaciens, Bacillus stearothermophilus, Pseudomonas aeroginosus, Pseudomonas fluorescens, Aspergillus oryzae, Aspergillus niger or Trichoderma reesei.

Furthermore, any mixtures of the above-mentioned enzymes are preferred. In order to make the process cost-effective, it is preferred to choose the enzyme activity of the at least one enzyme in the range from 0.01 to 5 units/g triglyceride-containing composition, more preferably in the range from 0.1 to 3 units/g triglyceride-containing composition, more preferably in the range from 0.2 to 2.5 units/g triglyceride-containing composition and most preferably in the range from 0.3 to 1 unit/g triglyceride-containing composition. (Unit: international unit for enzyme activity; 1 unit corresponds to the substrate conversion of 1 μmol/min.)

In other words, the amount of enzyme is used in relation to the triglyceride-containing composition in a range from 10 to 500 ppm, more preferably from 15 to 200 ppm, even more preferably from 20 to 100 ppm.

It is likewise preferred within the scope of the present invention if, for example when using two different enzymes, the ratio of the enzyme activity of the at least one first enzyme (preferably phospholipid-cleaving) to the enzyme activity of the second enzyme (preferably glycoside-cleaving) is in the range from 0.01:6 units/g triglyceride-containing composition to 6:0.01 units/g triglyceride-containing composition, preferably in the range from 0.1:3 units/g triglyceride-containing composition to 3:0.1 units/g triglyceride-containing composition. It is also preferred if the proportion of the two enzymes is equal, for example both components are chosen in the range from 0.1 to 0.5 unit/g triglyceride-containing composition.

The at least one enzyme can, for example, be lyophilized and used in solution in corresponding enzyme buffer (standard buffers for each enzyme are described in the literature), for example citrate buffer 0.1 M, pH 5 or acetate buffer 0.1 M, pH 5. In a preferred embodiment, the at least one enzyme is taken up in enzyme buffer and added to the triglyceride-containing composition. In order to achieve better solubility of the at least one enzyme, the addition of organic solvents is also possible. Preference is given to the use of non-polar organic solvents, for example hexane or acetone or mixtures, preferably in an amount of from 1 to 30% by weight. Further preferred constituents are selected from the group consisting of citrate buffers and acetate buffers.

In a further preferred embodiment, the at least one enzyme is used in supported form. Preferred support materials within the scope of the present invention are inorganic support materials, for example silica gels, precipitated silicas, silicates or aluminosilicates, and organic support materials, for example methacrylates or ion-exchange resins. The support materials facilitate the recyclability of the enzyme from the triglyceride-containing composition.

The “contacting” of the triglyceride-containing composition with the at least one solubilizer according to step a) of the method of the invention can be carried out within the scope of the method of the invention in any manner known to the person skilled in the art as being suitable for the purpose according to the invention. The preferred type of contacting according to step a) of the method of the invention is mixing of the triglyceride-containing composition and the at least one solubilizer.

After the contacting of the triglyceride-containing composition with the at least one solubilizer according to step a) of the method of the invention, the mixture of the triglyceride-containing composition and the at least one solubilizer is preferably stirred, more preferably with a blade stirrer at from 200 to 800 rpm, preferably from 250 to 600 rpm and most preferably at from 300 to 500 rpm.

The temperature of the mixture during the contacting according to step a) of the method of the invention is preferably in the range from 15 to 99° C., more preferably in the range from 20 to 95° C., further preferably from 22 to 90° C., likewise preferably from 35 to 85° C., further preferably from 40 to 85° C.

The duration of the contacting according to step a) of the method of the invention is preferably in the range from 1 minute to 12 hours, more preferably from 5 minutes to 10 hours, likewise preferably from 10 minutes to 6 hours, further preferably from 10 minutes to 3 hours.

The pH of the mixture during the contacting according to step a) of the method of the invention is preferably in the range from pH 3 to pH 7.5, more preferably in the range from pH 4 to pH 6 and more preferably in the range from pH 4.0 to pH 5.5.

In a preferred embodiment of the method of the invention, at least one enzyme is added to the triglyceride-containing composition before the gum phase is separated from the triglyceride-containing composition according to step (b).

The at least one enzyme can be added at the same time as, before or else after the contacting with the at least one solubilizer. It is preferred within the scope of the present invention if the triglyceride-containing composition is first contacted with the at least one solubilizer before the at least one enzyme is added. Where the triglyceride-containing composition is first contacted with the at least one solubilizer, it is particularly preferred if, before the addition of the at least one enzyme, stirring is carried out for from 1 to 300 minutes, preferably from 2 to 100 minutes, likewise preferably from 3 to 30 minutes and most preferably from 5 to 15 minutes.

The “separation” of the gums according to step b) of the method of the invention can be carried out in any manner known to the person skilled in the art as being suitable for the purpose according to the invention. However, the separation preferably takes place by means of separators of any kind, for example centrifuges or filtration units. Preferred separators for the method of the invention are nozzle separators, screw press separators, chamber separators, disk separators, solid-wall disk separators, two-phase decanters, three-phase decanters, three-pillar centrifuges, single-buffer centrifuges, sliding vibratory centrifuges, vibratory centrifuges, solid-wall peeler centrifuges, solid-wall screw centrifuges, tubular centrifuges, basket peeler centrifuges, pusher centrifuges, screen screw centrifuges, swarf centrifuges, inverting filter centrifuges and universal centrifuges. In the centrifugation, a phase separation of the triglyceride-containing composition takes place so that, for example in the preferred embodiment in which crude vegetable oil is used as the triglyceride-containing composition, the treated vegetable oil, the gums and—where present—the enzyme component are present in separate phases which can readily be separated from one another.

In a further aspect, the present invention relates to a degummed triglyceride-containing composition obtained by the method of the invention as defined above and described in greater detail.

In a further aspect, the present invention relates to the use of one or more solubilizers for degumming of a triglyceride-containing composition. The above definition and preferred embodiments apply correspondingly.

Particularly preferred embodiments of the present invention are described hereinbelow, but these do not limit the scope of the present invention in any way and instead serve merely for further illustration:

### Preferred Embodiment A

Method comprising the steps of
(a) contacting a triglyceride-containing composition with at least one solubilizer;
(b) separating the gum phase from the triglyceride-containing composition;
   wherein the triglyceride-containing composition is a crude oil, preferably a crude vegetable oil, and the solubilizer is selected from the group consisting of emulsifiers and co-emulsifiers and mixtures thereof, these preferably being propane-1,2-diol and propane-1,3-diol. The at least one solubilizer is used preferably in a concentration of from 0.005 to 10% by weight, more preferably from 0.01 to 5% by weight and most preferably from 0.075 to 3% by weight.

### Preferred Embodiment B

Method comprising the steps of
(a) contacting a triglyceride-containing composition with at least one solubilizer;
(a (i)) adding at least one enzyme;
(b) separating the gum phase from the triglyceride-containing composition;
   wherein the triglyceride-containing composition is a crude oil, preferably a crude vegetable oil, and the solubilizer is selected from the group consisting of emulsifiers and co-emulsifiers and mixtures thereof, these preferably being propane-1,2-diol and propane-1,3-diol. The at least one solubilizer is used preferably in a concentration of from 0.005 to 10% by weight, more preferably from 0.01 to 5% by weight and most preferably from 0.075 to 3% by weight. The at least one enzyme is selected from the group consisting of phospholipases and glucosidases and mixtures thereof, preferably phospholipase A1, A2 and/or C and/or alpha- and/or beta-glucosidase. The at least one enzyme is preferably added after or together with the at least one solubilizer.

### Preferred Embodiment C

Method according to embodiment A) or B), wherein the triglyceride-containing composition is pre-conditioned vegetable oil.

### Preferred Embodiment D

Method according to embodiment A) or B), wherein the triglyceride-containing composition is degummed vegetable oil.

### Preferred Embodiment E

Method according to one of embodiments A) to D), wherein, before the contacting according to step (a), water and/or acid and/or alkali is added to the crude vegetable oil without a separating step being carried out before the separation of the gum phase according to step (b).

### Preferred Embodiment F

Method as described in embodiment A, wherein the solubilizer is selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol and heptane-1,7-diol.

### Preferred Embodiment G

Method as described in embodiment B, wherein the solubilizer is selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol and heptane-1,7-diol.

### Preferred Embodiment H

Method as described in embodiment C, wherein the solubilizer is selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol and heptane-1,7-diol.

### Preferred Embodiment I

Method as described in embodiment D, wherein the solubilizer is selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol and heptane-1,7-diol.

### Preferred Embodiment J

Method as described in embodiment E, wherein the solubilizer is selected from the group consisting of 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol and heptane-1,7-diol.

### Methods

The following analytical methods were used:

### Determination of the Phosphorus Content in Vegetable Oils

Phosphorus was determined by ICP in accordance with DEV E-22.

### Determination of the Calcium and Magnesium Content in the Vegetable Oils

Calcium and magnesium were determined by ICP in accordance with DEV E-22.

Karl Fischer determination of water content

The water content of oil was determined according to Karl Fischer, DIN 51777.

### Determination of the Content of Free Fatty Acids (FFA)

The free fatty acids are determined using a Foodlab instrument from cdR (Italy), which is an independent, compact analytical device having a built-in spectrophotometer; it consists of a temperature-controlled incubation unit having 12 cells for cuvettes and 3 independent measuring cells each having 2 light beams of different wavelengths.

After switching on the Foodlab instrument for the photometric determination of the content of free fatty acids (FFA), the ready-to-use analytical cuvettes from CDR are pre-heated to 37° C., and then the method of FFA determination is selected from the menu and the blank value of the cuvette is determined. The required volume of vegetable oil is then pipetted into the solution of the measuring cuvette, consisting of a mix of various alcohols, KOH and phenolphthalein derivatives. Depending on the FFA content, a 2.5 μL sample is conventionally used for soybean oil and a 1 μL sample for rapeseed oil. The volume taken from the vegetable oil sample is discarded once in order to rinse the pipette, and then a sample is taken again and pipetted into the ready measuring solution. The pipette is thereafter rinsed exactly ten times with the measuring solution in order to distort the volume of the oil sample as little as possible. The cuvette is subsequently inverted and turned upright by hand ten times. The fatty acids in the sample (at pH<7.0) react with a chromogenic portion and form a color complex, the intensity of which is then determined at 630 nm in the measuring cell of the device. It is indicated by the device as percent of oleic acid and is proportional to the total acid concentration in the sample.

### Determination of the Gum Volume

By means of this determination, the gum phase of enzymatically untreated and enzymatically treated gum contained in the oil is measured. A 10 mL glass centrifuge tube is heated to the working temperature of the reaction mixture, and the samples (2×2 mL) are introduced and equilibrated centrifuged at 3000 rpm for at least 4 minutes in order to separate the gum phase from the oil. Samples are taken from the upper oil phases for analysis. For documentation purposes, the result of the phase formation is additionally photographed.

### Determination of the Oil Yield

The oil yield is determined via mass weighing of the oil, before and after the reaction.

### Determination of the HLB Value According to Griffin

The HLB value for non-ionic surfactants was calculated as follows:

$$HLB = 20 \times ( 1 - \frac{{M}_{1}}{M} )$$

where M₁ denotes the molar mass of the lipophilic portion of a molecule and M denotes the molar mass of the molecule as a whole. The factor 20 is a scaling factor chosen freely by Griffin. A scale from 0 to 20 is thus obtained.

An HLB value of 1 indicates a lipophilic compound, a chemical compound having an HLB value of 20 has a high hydrophilic portion. A value between 3 and 8 is assigned to water/oil (W/O) emulsifiers, between 8 and 18 it is assigned to O/W emulsifiers.

### EXAMPLES AND FIGURES

The invention is elucidated in detail below by means of examples and figures. It is here emphasized that the examples and figures are merely illustrative in nature and illustrate particularly preferred embodiments of the present invention and do not limit the scope of the present invention in any way.

The figures show:

FIG. 1 the oil yield after the degumming of crude soybean oil with different concentrations of propane-1,2-diol in comparison with standard degumming without propane-1,2-diol;

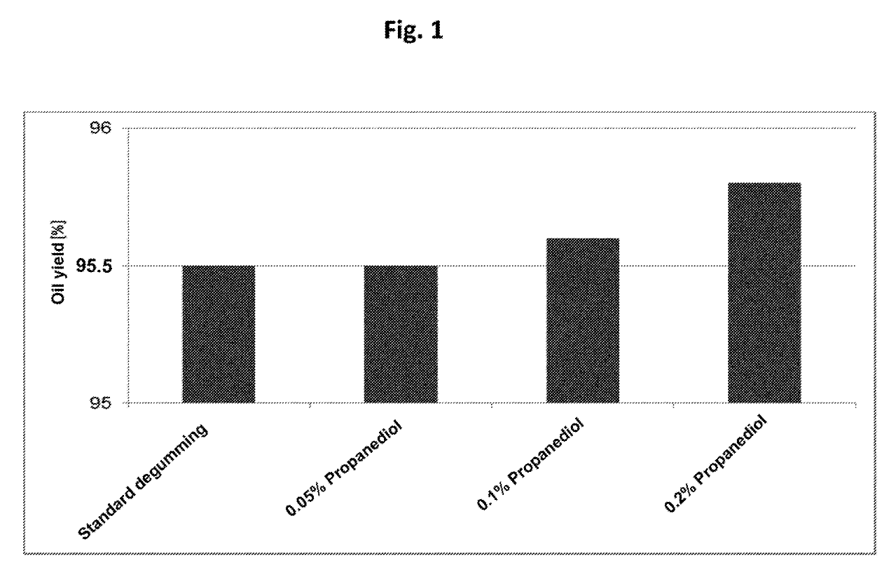

FIG. 2 the oil yield after the degumming of crude soybean oil with different concentrations of propane-1,2-diol and 0.5 U/g oil of PLA1 in comparison with PLA1 standard degumming (0.5 U/g oil) without propane-1,2-diol

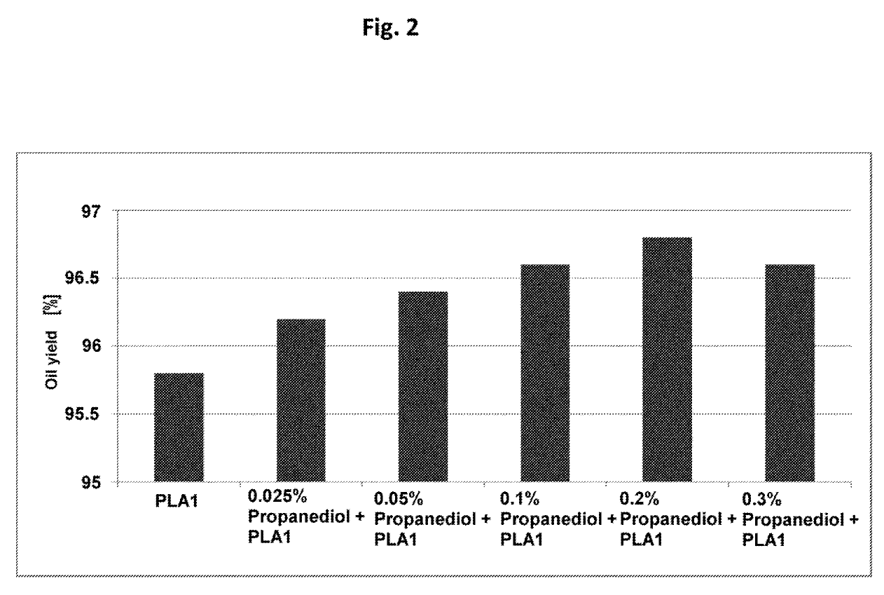

FIG. 3 separation of the soybean oil on the pilot plant scale after the aqueous degumming

FIG. 4 separation of the soybean oil on the pilot plant scale after the aqueous degumming with addition of 2.2% by weight of propane-1,2-diol

The examples were carried out on the basis of the following reaction variants, to which they relate:

TABLE 1
Solubilizers used

| | | HLB |
|---|---|---|
| Additive | Formula | value |
| Propane-1,2-diol | 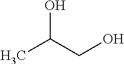 | 8.70 |
| 1-Octanol | 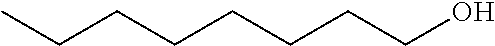 | 2.65 |
| 2,2-Dimethyl- propane-1,3-diol | 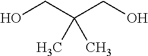 | 6.56 |
| Butane-2,3-diol | 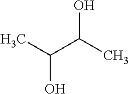 | 7.57 |
| Butanol | 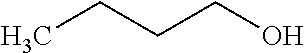 | 4.62 |
| Ethanol | 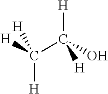 | 7.42 |
| Isopropanol | 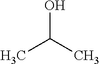 | 5.69 |
| Polyglycol | Ethylene oxide-polypropylene oxide | 9.58 |
| B11/50 | monobutyl ether, mean | |
| | molecular weight: 1300 g/mol | |
| 1-Pentanol | 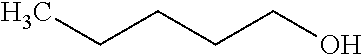 | 3.89 |
| 3-Pentanol | 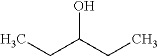 | 3.89 |
| 2-Methylpentane- 2,4-diol | 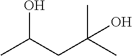 | 5.78 |
| 1-Hexanol | 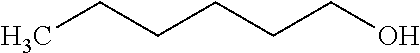 | 3.36 |
| 3-Hexanol | 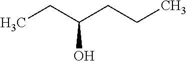 | 3.36 |
| Hexane-1,6-diol | 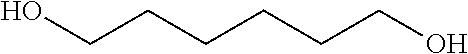 | 5.78 |
| Hexane-1,2-diol | 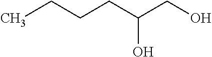 | 5.78 |
| Hexane-2,5-diol | 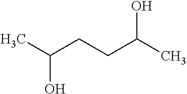 | 5.78 |
| 1-Heptanol | 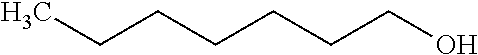 | 2.96 |
| 3-Heptanol | 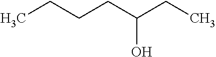 | 2.96 |
| Heptane-1,7-diol | 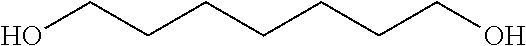 | 5.17 |

Reaction Variant 1: Degumming of Crude Oil with Citric Acid, Complete Neutralization

The amount of crude oil to be treated, from 400 to 600 g, is introduced into a 1000 mL DN120 Duran reactor, and samples are taken for analysis. The oil in the Duran reactor is heated by means of a hotplate to a temperature of from 40 to 85° C., preferably from 45 to 80° C. As soon as the desired temperature is reached, the pre-conditioning is begun. To that end, a defined amount, dependent on the amount of oil, of citric acid (e.g. 1000 ppm) is metered into the oil. The mixture is then dispersed with an Ultraturrax® for 5 seconds to 1 minute and the reaction mixture is mixed thoroughly at 150 rpm for a further 15 minutes until the reaction of the acid has taken place. Alternatively, the reaction mixture can be incubated at approximately 600 rpm with vigorous stirring. A defined amount of sodium hydroxide solution (1 mol/L, residual amount to 1.5 to 2.5% by volume minus water from acid addition and enzyme addition) is then added. The aim of adding the sodium hydroxide solution is complete neutralization of the acid including the free fatty acids in the oil. This requires an alkali excess of 10-30%, preferably 20%. The amount of sodium hydroxide solution required is calculated by the amounts of the acids and the molar mass thereof. Alternatively, a pH of from 7 to 8 can be established with an excess of sodium hydroxide solution. After cooling to 48° C. or after the temperature has been maintained at 45° C. or 80° C., the sodium hydroxide solution can be dispersed with an Ultraturrax® for 5 seconds. The reaction mixture is mixed thoroughly for a further 10 minutes. Subsequently, the residual amount of water (0.5 to 5%) minus the amount of water already added through addition of acid and alkali is fed in. The temperature over the entire reaction remains at 45 to 48° C. or at 80° C.

The addition of one or more solubilizers (0.05 to 0.3% by weight of solubilizer/oil) can be effected at different times during the overall reaction; see table 2 below. For this purpose, the stirrer speed can be increased for a short time (1 minute at 900 rpm), and then stirring is continued at a lower speed (150 rpm).

Samples are taken at defined time intervals. The sample is taken by means of a pipette, introduced into a temperature-controlled glass centrifuge tube (temperature of the reaction mixture), the temperature is adjusted, and it is centrifuged at 3000 rpm for at least 4 minutes in order to separate the gum phase from the oil. For documentation purposes, the result of the phase formation is photographed; samples of the supernatant are taken for determination of the phosphorus, calcium and magnesium content.

The separation of the gum phase from the oil is effected by the following steps:

1. Switching off the stirrer
2. Transferring the oil to a centrifuge cup
3. Heating the filled centrifuge cup in a drying cabinet at 80° C. for 15 minutes
4. Separating oil and heavy phase in the Eppendorf 5810 R laboratory centrifuge at 4000 rpm for 10 minutes.

### Dosage Variants for the Solubilizers:

The solubilizers listed above can be added to reaction variant 1 at various times. The dosage times are examples and can be effected at any time during the reaction.

TABLE 2
Varying dosage times for the solubilizers in
the course of acid degumming with full neutralization:

| | |
|---|---|
| A | Prior to addition of acid |
| B | Simultaneously with addition of acid |
| C | After the addition of acid, prior to the |
| | addition of alkali |
| D | Simultaneously with addition of alkali |
| E | After the addition of alkali, prior to the |
| | addition of water |
| F | After addition of water |
| G | Before the end of the reaction |

### Reaction Variant 2: Crude Oil, Aqueous Pre-Degumming (Lecithin Production)

In a further reaction variant, 0.05 to 5% by volume of water is added to the crude oil. The emulsion is mixed thoroughly. Ideally, the reaction is conducted at 30 to 80° C., preferably at 40 to 78° C. Subsequently, the phase separation is awaited and the solids settle out or can be removed by a standard method known to the person skilled in the art, for example via centrifugation or filtration.

The separation of the gum phase from the oil is effected by the following steps:

1. Switching off the stirrer
2. Transferring the oil to a centrifuge cup
3. Heating the filled centrifuge cup in a drying cabinet at 80° C. for 15 minutes
4. Separating oil and heavy phase in the Eppendorf 5810 R laboratory centrifuge at 4000 rpm for 10 minutes.

The addition of one or more solubilizers (0.05 to 0.3% by weight of solubilizer/oil) can be effected at different times, for example prior to the addition of water or after the addition of water, over the entire reaction; see table 3 below. For this purpose, the stirrer speed can be increased for a short time (1 minute at 900 rpm), and then stirring is continued at a lower speed (150 rpm).

### Dosage Variants for the Solubilizers:

The solubilizers listed above can be added to reaction variant 2 at various times. The dosage times are examples and can be effected at any time during the reaction.

TABLE 3
Varied dosage times for the solubilizers in
the course of water degumming:

| | |
|---|---|
| A | Prior to addition of water |
| B | After the addition of water |
| C | At the end of the reaction |

### Reaction Variant 3: Crude Oil, Partial Neutralization

The amount of crude oil to be treated, from 400 to 600 g, is introduced into a 1000 mL DN120 Duran reactor, and samples are taken for analysis. The oil in the Duran reactor is heated by means of a hotplate to a temperature of from 40 to 85° C., preferably from 48 to 80° C. As soon as the temperature is reached, the pre-conditioning is begun. To that end, a defined amount, dependent on the amount of oil, of citric acid (e.g. 1000 ppm) is metered into the oil. The mixture is then mixed thoroughly with an Ultraturrax® for 1 minute. Alternatively, the mixture is incubated at approximately 600 rpm for 15 minutes with stirring, in order to await the reaction of the acid. A defined amount of sodium hydroxide solution (4 mol/L, residual amount to 1.5 to 2.5% by volume minus water from acid addition) is then added until a pH of about 4 to 5 has been attained, and the mixture is incubated while stirring for further a 10 minutes. Subsequently, the residual amount of water (0.5 to 5% by volume) minus the amount of water already added through addition of acid and alkali is fed in. The temperature over the entire reaction remains at 45 to 80° C.

The addition of one or more solubilizers (0.05 to 0.3% by weight of solubilizer/oil) can be effected at different times during the overall reaction; see table 4. For this purpose, the stirrer speed can be increased for a short time (1 minute at 900 rpm), and then stirring is continued at a lower speed (150 rpm).

Samples are taken at defined time intervals. The sample is taken by means of a pipette, introduced into a temperature-controlled glass centrifuge tube (temperature of the reaction mixture), the temperature is adjusted, and it is centrifuged at 3000 rpm for at least 4 minutes in order to separate the gum phase from the oil. For documentation purposes, the result of the phase formation is photographed; samples of the supernatant are taken for determination of the phosphorus, calcium and magnesium content.

The separation of the gum phase from the oil is effected by the following steps:

1. Switching off the stirrer
2. Transferring the oil to a centrifuge cup
3. Heating the filled centrifuge cup in a drying cabinet at 80° C. for 15 minutes
4. Separating oil and heavy phase in the Eppendorf 5810 R laboratory centrifuge at 4000 rpm for 10 minutes.

### Dosage Variants for the Solubilizers:

The solubilizers listed above can be added to reaction variant 3 at various times. The dosage times are examples and can be effected at any time during the reaction.

TABLE 4
Varied dosage times for the solubilizers in
the course of acid degumming with partial
neutralization:

| | |
|---|---|
| A | Prior to addition of acid |
| B | Simultaneously with addition of acid |
| C | After the addition of acid, prior to the |
| | addition of alkali |
| D | Simultaneously with addition of alkali |
| E | After the addition of alkali, prior to the |
| | addition of water |
| F | After addition of water |
| G | Before the end of the reaction |

Reaction Variant 4: Crude Oil, Partial Neutralization with Enzyme

The amount of crude oil to be treated, from 400 to 600 g, is introduced into a 1000 mL DN120 Duran reactor, and samples are taken for analysis. The oil in the Duran reactor is heated by means of a hotplate to a temperature of from 40 to 85° C., preferably from 48 to 80° C. As soon as the temperature is reached, the pre-conditioning is begun. To that end, a defined amount, dependent on the amount of oil, of citric acid (e.g. 1000 ppm) is metered into the oil. The mixture is then mixed thoroughly with an Ultraturrax® for 1 minute. Alternatively, the mixture is incubated at approximately 600 rpm for 15 minutes with stirring, in order to await the reaction of the acid. A defined amount of sodium hydroxide solution (4 mol/L, residual amount to 1.5 to 2.5% by volume minus water from acid addition and enzyme addition) is then added until a pH of about 4 to 5 has been attained, and the mixture is incubated while stirring for a further 10 minutes. After cooling to 48° C., an enzyme, an enzyme mixture or an immobilizate is added, for which the stirrer speed can be increased briefly (to 900 rpm for 1 minute), then stirring is continued at a lower speed. Subsequently, the residual amount of water (0.5 to 5% by volume) minus the amount of water already added through addition of acid and alkali is fed in. The temperature over the entire reaction remains at 45 to 80° C. The choice of temperature depends here on the thermal stability of the enzyme or enzyme mixture used in each case.

The addition of one or more solubilizers (0.05 to 0.3% by weight of solubilizer/oil) can be effected at different times during the overall reaction; see table 5. For this purpose, the stirrer speed can be increased for a short time (1 minute at 900 rpm), and then stirring is continued at a lower speed (150 rpm).

Samples are taken at defined time intervals. The sample is taken by means of a pipette, introduced into a temperature-controlled glass centrifuge tube (temperature of the reaction mixture), the temperature is adjusted, and it is centrifuged at 3000 rpm for at least 4 minutes in order to separate the gum phase from the oil. For documentation purposes, the result of the phase formation is photographed; samples of the supernatant are taken for determination of the phosphorus, calcium and magnesium content.

The separation of the gum phase from the oil is effected by the following steps:

1. Switching off the stirrer
2. Transferring the oil to a centrifuge cup
3. Heating the filled centrifuge cup in a drying cabinet at 80° C. for 15 minutes
4. Separating oil and heavy phase in the Eppendorf 5810 R laboratory centrifuge at 4000 rpm for 10 minutes.

### Dosage Variants for the Solubilizers:

The solubilizers listed above can be added to reaction variant 4 at various times. The dosage times are examples and can be effected at any time during the reaction.

TABLE 5
Varied dosage times for the solubilizers in
the course of acid degumming with partial
neutralization and addition of enzyme:

| | |
|---|---|
| A | Prior to addition of acid |
| B | Simultaneously with addition of acid |
| C | After the addition of acid, prior to the |
| | addition of alkali |
| D | Simultaneously with addition of alkali |
| E | After the addition of alkali, prior to the |
| | addition of water |
| F | After addition of water |
| G | Before the end of the reaction |

### Reaction Variant 5: Crude Oil

The amount of crude oil to be treated, from 400 to 600 g, is introduced into a 1000 mL DN120 Duran reactor, and samples are taken for analysis. The oil in the Duran reactor is heated by means of a hotplate to a temperature of from 40 to 85° C., preferably from 48 to 80° C. As soon as the desired temperature is reached, the pre-conditioning is begun. To that end, a defined amount, dependent on the amount of oil, of citric acid (e.g. 1000 ppm) is metered into the oil. The mixture is then mixed thoroughly with an Ultraturrax® for 1 minute. Alternatively, the mixture is incubated at approximately 600 rpm for 15 minutes with stirring, in order to await the reaction of the acid. A defined amount of sodium hydroxide solution (1 mol/L, residual amount to 1.5 to 2.5% by volume minus water from acid addition and enzyme addition) is then added until a pH of about 4 to 5 has been attained, and the mixture is incubated while stirring for a further 10 minutes. Alternatively, it is possible to use an excess of sodium hydroxide solution to set a pH of 7 to 8 and incubate while stirring for a further 10 minutes. After cooling to 48° C. or after keeping the temperature at 80° C., propane-1,2-diol is added as solubilizer (0.05 to 0.3% by weight of propane-1,2-diol oil), for which the stirrer speed can be increased briefly (to 900 rpm for 1 minute), then stirring is continued at lower speed.

Samples are taken at defined time intervals. The sample is taken by means of a pipette, introduced into a temperature-controlled glass centrifuge tube (temperature of the reaction mixture), the temperature is adjusted, and it is centrifuged at 3000 rpm for at least 4 minutes in order to separate the gum phase from the oil. For documentation purposes, the result of the phase formation is photographed; samples of the supernatant are taken for determination of the phosphorus, calcium and magnesium content.

### Reaction Variant 6: Crude Oil

The amount of crude oil to be treated, from 400 to 600 g, is introduced into a 1000 mL DN120 Duran reactor, and samples are taken for analysis. The oil in the Duran reactor is heated by means of a hotplate to a temperature of from 40 to 85° C., preferably from 48 to 80° C. As soon as the temperature is reached, the pre-conditioning is begun. To that end, a defined amount, dependent on the amount of oil, of citric acid (e.g. 1000 ppm) is metered into the oil. The mixture is then mixed thoroughly with an Ultraturrax® for 1 minute. Alternatively, the mixture is incubated at approximately 600 rpm for 15 minutes with stirring, in order to await the reaction of the acid. A defined amount of sodium hydroxide solution (1 mol/L, residual amount to 1.5 to 2.5% by volume minus water from acid addition and enzyme addition) is then added until a pH of about 4 to 5 has been attained, and the mixture is incubated while stirring for a further 10 minutes. After cooling to 48° C., propane-1,2-diol as solubilizer and an enzyme, an enzyme mixture or an immobilizate are added, for which the stirrer speed can be increased briefly (to 900 rpm for 1 minute), then stirring is continued at lower speed.

Samples are taken at defined time intervals. The sample is taken by means of a pipette, introduced into a temperature-controlled glass centrifuge tube (temperature of the reaction mixture), the temperature is adjusted, and it is centrifuged at 3000 rpm for at least 4 minutes in order to separate the gum phase from the oil. For documentation purposes, the result of the phase formation is photographed; samples of the supernatant are taken for determination of the phosphorus, calcium and magnesium content.

### EXAMPLES

### Example 1

According to reaction variant 5, a crude soybean oil with the following starting contents was used: phosphorus 860 ppm, calcium 63 ppm, magnesium 60 ppm and a content of free fatty acids of 0.45%. The crude oil was heated to 80° C. and subjected at this temperature to pre-conditioning by means of aqueous citric acid (1000 ppm) and was then neutralized to pH 7 to 8 with aqueous sodium hydroxide solution (1 mol/L). Different concentrations of propane-1,2-diol (0.05 to 0.2% by weight propanediol) were then added and stirring was continued. As comparison, a sample was stirred without propane-1,2-diol (standard degumming). The oil/water ratio (weight) was 98.5:1.5. Samples were taken at regular intervals (see table 6). At the end of the reaction, the gum phase was removed by centrifugation and the oil yield was determined via mass weighing.

The results are summarized in table 6. It can clearly be seen that an increasing concentration of propane-1,2-diol leads to a decrease in the calcium (Ca), magnesium (Mg) and phosphorus (P) ions. In the standard degumming of the soybean oil, the following ion values were achieved after a reaction time of one hour: Ca: 4.7 ppm; Mg: 3.7 ppm and P: 42 ppm. After a reaction time of one hour, the following ion values were achieved with 0.2% by weight propane-1,2-diol: Ca: 1.1 ppm; Mg: 0.69 ppm and P: 10 ppm. In addition, the oil yield increases with propane-1,2-diol from 95.5 to 95.8% by weight. The values were confirmed in repeat determinations. It was thus shown that the oil degumming is more effective and a higher oil yield is achieved as a result of the addition of propane-1,2-diol.

TABLE 6
Degumming with different concentrations of
propane-1,2-diol in comparison with standard degumming

| Test | | 10 min. | 60 min. | Oil yield [%] |
|---|---|---|---|---|
| Standard | Ca [ppm] | 7.6 | 4.7 | 95.5 |
| degumming | Mg [ppm] | 6.5 | 3.7 | |
| | P [ppm] | 77 | 42 | |
| | FFA [%] | 0.11 | 0.16 | |
| 0.05% | Ca [ppm] | 1.5 | 2.2 | 95.5 |
| propane-1,2- | Mg [ppm] | 1.2 | 1.8 | |
| diol | P [ppm] | 12 | 20 | |
| | FFA [%] | 0.07 | 0.15 | |
| 0.1% | Ca [ppm] | 1.6 | 2.2 | 95.6 |
| propane-1,2- | Mg [ppm] | 1.2 | 1.7 | |
| diol | P [ppm] | 12 | 18 | |
| | FFA [%] | 0.08 | 0.12 | |
| 0.2% | Ca [ppm] | 1.6 | 1.1 | 95.8 |
| propane-1,2- | Mg [ppm] | 1.2 | 0.9 | |
| diol | P [ppm] | 13 | 10 | |
| | FFA [%] | 0.11 | 0.15 | |

### Example 2

According to reaction variant 6, a crude soybean oil with the following starting contents was used: phosphorus 860 ppm, calcium 63 ppm, magnesium 60 ppm and a content of free fatty acids of 0.45%. The crude oil was subjected to pre-conditioning by means of aqueous citric acid (1000 ppm) and was then neutralized to pH 4-5 with aqueous sodium hydroxide solution (1 mol/L). A phospholipase A1 (PLA1) from Thermomyces lanuginosus and various concentrations of propane-1,2-diol (0.05 to 0.2% by weight) were then added according to reaction variant 6 and stirring was continued. As comparison, a sample without propane-1,2-diol (PLA1 standard degumming) was stirred. The oil/water ratio (weight) was 98.5:1.5. Samples were taken at regular intervals. At the end of the reaction, the gum phase was removed by centrifugation and the oil yield was determined via mass weighing. The reaction temperature was kept at 48° C. over the entire reaction time. With regard to the separation, the procedure was as described in reaction variant 6. Prior to the separation, the samples were each preheated to 80° C.

The results are summarized in table 7. It can clearly be seen that an increasing concentration of propane-1,2-diol leads to an increased oil yield and that the use, for example, of 0.2% by weight propane-1,2-diol+PLA1 permits a further increase by approximately 1% degummed soybean oil. The values were confirmed in repeat determinations. It was thus shown that the oil degumming is more effective and a higher oil yield is achieved as a result of the addition of propane-1,2-diol.

TABLE 7
Degumming with different concentrations of
propane-1,2-diol and PLA1 in comparison with PLA1
standard degumming

| | | | | Oil |
|---|---|---|---|---|
| | | | | yield |
| Test | | 10 min. | 60 min. | [%] |
| 0.5 U/g PLA1 | Ca [ppm] | 0.5 | 0.5 | 95.8 |
| standard | Mg [ppm] | 0.5 | 0.5 | |
| degumming | P [ppm] | 4.7 | 4.8 | |
| | FFA [%] | 0.15 | 0.31 | |
| | Gum [%] | 6.6 | 4.9 | |
| 0.025% | Ca [ppm] | 1 | 0.3 | 96.2 |
| propanediol + | Mg [ppm] | 0.9 | 0.3 | |
| 0.5 U/g | P [ppm] | 10 | 3.6 | |
| PLA1 | FFA [%] | 0.26 | 0.45 | |
| | Gum [%] | 3.9 | 2.8 | |
| 0.1% | Ca [ppm] | 0.9 | 1 | 96.6 |
| propanediol + | Mg [ppm] | 0.9 | 1 | |
| 0.5 U/g | P [ppm] | 7.5 | 9.6 | |
| PLA1 | FFA [%] | 0.20 | 0.32 | |
| | Gum [%] | 5.5 | 3.1 | |
| 0.2% | Ca [ppm] | 1 | 0.3 | 96.8 |
| propanediol + | Mg [ppm] | 0.9 | 0.3 | |
| 0.5 U/g | P [ppm] | 10 | 3.6 | |
| PLA1 | FFA [%] | 0.26 | 0.45 | |
| | Gum [%] | 3.9 | 2.8 | |

### Example 3: Water Degumming/Lecithin Production in the Case of Crude Soybean Oil and Crude Rapeseed Oil (Reaction Variant 2)

Within the scope of this example, the effect of the additives of the invention on the aqueous degumming of crude soybean oil and crude rapeseed oil was examined. For this purpose, the solubilizers were used in a concentration of 0.2% by weight based on the amount of oil. The crude vegetable oils used for this purpose are characterized by the following analytical data:

TABLE 8
Characterization data of the oils used in
example 3

| | Crude soybean oil | Crude rapeseed oil |
|---|---|---|
| Ca content [ppm] | 195 | 230 |
| Mg content [ppm] | 150 | 74 |
| P content [ppm] | 1100 | 1150 |
| FFA content [%] | 0.42 | 1.2 |

530 g of crude vegetable oil (crude soybean and rapeseed oil), after weighing the reactor pot, were introduced into a Duran reactor, heated to 60° C. and stirred at a stirrer speed of 150 rpm.

This was followed by the addition of water and any solubilizer: 2.5% total water was used in the case of soybean oil and 3% total water in the case of rapeseed oil.

In the inventive batches, the additive was first mixed with the water in a beaker and then introduced into the Duran reactor via a funnel. The mixture was stirred at 60° C. for 60 minutes. Thereafter, samples for the analyses of the content of P, Ca, Mg and the free fatty acids were taken from the reaction mixture.

Finally, the reaction mixture was heated up to 80° C. to prepare for the separation, the stirrer was switched off and the reaction mixture was left to stand for 5 minutes. Thereafter, the oil (reaction mixture) was transferred into a centrifuge cup and heated at 80° C. in a drying cabinet for another 15 minutes, then centrifuged at 4000 rpm in a laboratory centrifuge for 10 minutes. Finally, the oil phase was emptied and the mass of heavy phase was determined via the weighing of the centrifuge cup. Finally, the oil yield was determined by weighing the oil remaining after the degumming using the mass of the oil used.

TABLE 9
Results of the aqueous degumming of crude
soybean oil with and without additives of the invention
Soybean oil

| | | | Oil |
|---|---|---|---|
| | | | yield |
| Experiment | | 60 min. | [%] |
| Water degumming | Ca [ppm] | 147 | 94.7 |
| (standard degumming) | Mg [ppm] | 67 | |
| | P [ppm] | 275 | |
| | FFA [%] | 0.32 | |
| | Gum [%] | 5.8 | |
| 0.20% | Ca [ppm] | 135 | 94.8 |
| 1-octanol | Mg [ppm] | 61 | |
| | P [ppm] | 245 | |
| | FFA [%] | 0.29 | |
| | Gum [%] | 5.3 | |
| 0.20% | Ca [ppm] | 152 | 95.0 |
| 1-heptanol | Mg [ppm] | 69 | |
| | P [ppm] | 290 | |
| | FFA [%] | 0.31 | |
| | Gum [%] | 5.7 | |
| 0.20% | Ca [ppm] | 145 | 95.0 |
| 3-heptanol | Mg [ppm] | 66 | |
| | P [ppm] | 275 | |
| | FFA [%] | 0.29 | |
| | Gum [%] | 5.7 | |
| 0.20% | Ca [ppm] | 145 | 94.9 |
| 1-hexanol | Mg [ppm] | 62 | |
| | P [ppm] | 310 | |
| | FFA [%] | — | |
| | Gum [%] | 5.1 | |
| 0.20% | Ca [ppm] | 136 | 94.9 |
| 3-hexanol | Mg [ppm] | 63 | |
| | P [ppm] | 250 | |
| | FFA [%] | 0.3 | |
| | Gum [%] | 5.5 | |
| 0.20% | Ca [ppm] | 145 | 95.0 |
| 1-pentanol | Mg [ppm] | 66 | |
| | P [ppm] | 275 | |
| | FFA [%] | 0.29 | |
| | Gum [%] | 5.5 | |
| 0.20% | Ca [ppm] | 150 | 95.0 |
| 3-pentanol | Mg [ppm] | 68 | |
| | P [ppm] | 295 | |
| | FFA [%] | — | |
| | Gum [%] | 5.5 | |
| 0.20% | Ca [ppm] | 116 | 95.7 |
| heptane-1,7-diol | Mg [ppm] | 57 | |
| | P [ppm] | 210 | |
| | FFA [%] | — | |
| | Gum [%] | 3.8 | |
| 0.20% | Ca [ppm] | 128 | 95.2 |
| 2-methylpentane-2,4-diol | Mg [ppm] | 61 | |
| | P [ppm] | 235 | |
| | FFA [%] | 0.31 | |
| | Gum [%] | 4.5 | |
| 0.20% | Ca [ppm] | 155 | 95.6 |
| hexane-1,6-diol | Mg [ppm] | 76 | |
| | P [ppm] | 260 | |
| | FFA [%] | — | |
| | Gum [%] | 3.2 | |
| 0.20% | Ca [ppm] | 145 | 95.2 |
| hexane-1,2-diol | Mg [ppm] | 62 | |
| | P [ppm] | 300 | |
| | FFA [%] | — | |
| | Gum [%] | 4.6 | |
| 0.20% | Ca [ppm] | 153 | 95.6 |
| hexane-2,5-diol | Mg [ppm] | 75 | |
| | P [ppm] | 250 | |
| | FFA [%] | — | |
| | Gum [%] | 3.7 | |
| 0.20% | Ca [ppm] | 142 | 95.5 |
| 2,2-dimethylpropane-1,3-diol | Mg [ppm] | 62.3 | |
| | P [ppm] | 250 | |
| | FFA [%] | 0.30 | |
| | Gum [%] | 4.0 | |
| 0.20% | Ca [ppm] | 140 | 95.1 |
| butane-2,3-diol | Mg [ppm] | 65 | |
| | P [ppm] | 260 | |
| | FFA [%] | 0.29 | |
| | Gum [%] | 4.4 | |
| 0.20% | Ca [ppm] | 140 | 95.1 |
| propane-1,2-diol | Mg [ppm] | 70 | |
| | P [ppm] | 255 | |
| | FFA [%] | — | |
| | Gum [%] | 4.6 | |

The studies with different solubilizers at a dosage of 0.2% by weight in each case show a significant increase in the oil yield for some of the solubilizers. The best results are shown by heptane-1,7-diol, hexane-2,6-diol, hexane-2,5-diol and 2,2-dimethylpropane-1,3-diol. With these additives, under the conditions specified, an increase in the oil yield by 1% or more is achieved.

Table 10 relating to example 3: Results of the aqueous degumming of crude rapeseed oil with and without additives of the invention

Rapeseed oil

| | | | Oil |
|---|---|---|---|
| | | | yield |
| Experiment | | 60 min. | [%] |
| Water degumming | Ca [ppm] | 43 | 93.8 |
| (standard degumming) | Mg [ppm] | 6.3 | |
| | P [ppm] | 50 | |
| | FFA [%] | 0.91 | |
| | Gum [%] | 5.7 | |
| 0.20% | Ca [ppm] | 50 | 93.6 |
| 1-octanol | Mg [ppm] | 7.1 | |
| | P [ppm] | 56 | |
| | FFA [%] | 0.94 | |
| | Gum [%] | 5.8 | |
| 0.20% | Ca [ppm] | 46 | 93.6 |
| 3-heptanol | Mg [ppm] | 6.4 | |
| | P [ppm] | 52 | |
| | FFA [%] | 1.02 | |
| | Gum [%] | 4.6 | |
| 0.20% | Ca [ppm] | 59 | 94.4 |
| heptane-1,7-diol | Mg [ppm] | 8.4 | |
| | P [ppm] | 70 | |
| | FFA [%] | 0.92 | |
| | Gum [%] | 4.4 | |
| 0.20% | Ca [ppm] | 61 | 93.8 |
| 2-methylpentane-2,4-diol | Mg [ppm] | 8.9 | |
| | P [ppm] | 80 | |
| | FFA [%] | 0.95 | |
| | Gum [%] | 5 | |
| 0.20% | Ca [ppm] | 48 | 93.8 |
| propane-1,2-diol | Mg [ppm] | 7.4 | |
| | P [ppm] | 63 | |
| | FFA [%] | 0.92 | |
| | Gum [%] | 5.5 | |

The results in the above table show that it is also possible with individual additives of the invention to increase the oil yield in the aqueous degumming of rapeseed oils.

Both in the aqueous degumming of soybean oil and in the aqueous degumming of rapeseed oil, the additives of the invention do not reduce the P values to a significant degree. This effect is desired because, in lecithin production from the aqueous gum, the non-hydratable phospholipids which remain in oil in this case should not be transferred to the aqueous gum. In the processing of the lecithin, these would merely dilute the hydratable phospholipids and especially the phosphatidylcholine and would have to be removed in a complex manner.

### Example 4: Water Degumming/Lecithin Production with Varied Times for Solubilizer Dosage for Soybean Oil (Reaction Variant 2)

In order to examine the influence of the time of dosage of the solubilizers on the oil yield, the solubilizer heptane-1,7-diol and propane-1,2-diol was selected. The studies were conducted with soybean oil according to example 3. The procedure followed was generally analogous to example 3, except that the time of dosage for the two solubilizers used was varied:

TABLE 11
relating to example 4: Water degumming/lecithin
production with varied times of solubilizer dosage for soybean
oil (using heptane-1,7-diol and propane-1,2-diol as solubilizer)
Soybean oil - heptane-1,7-diol solubilizer

| | | | oil |
|---|---|---|---|
| | | | yield |
| Experiment | | 60 min. | [%] |
| Water degumming | Ca [ppm] | 147 | 94.7 |
| No solubilizer | Mg [ppm] | 67 | |
| | P [ppm] | 275 | |
| | FFA [%] | 0.32 | |
| | Gum [%] | 5.8 | |
| 0.20% | Ca [ppm] | 116 | 95.7 |
| heptane-1,7-diol | Mg [ppm] | 57 | |
| as standard | P [ppm] | 210 | |
| with addition of water | FFA [%] | — | |
| | Gum [%] | 3.8 | |
| 0.20% | Ca [ppm] | 150 | 95.5 |
| heptane-1,7-diol | Mg [ppm] | 70 | |
| 5 minutes before addition of | P [ppm] | 280 | |
| water | FFA [%] | 0.31 | |
| | Gum [%] | 4 | |
| 0.20% | Ca [ppm] | 156 | 95.3 |
| heptane-1,7-diol | Mg [ppm] | 72 | |
| 30 minutes after addition of | P [ppm] | 295 | |
| water | FFA [%] | 0.31 | |
| | Gum [%] | 4 | |
| 0.20% | Ca [ppm] | 157 | 95.0 |
| heptane-1,7-diol | Mg [ppm] | 73 | |
| 5 minutes before the end of | P [ppm] | 300 | |
| reaction | FFA [%] | 0.32 | |
| | Gum [%] | 4 | |
| Soybean oil - propane-1,2- | Ca [ppm] | 140 | 95.1 |
| diol solubilizer | Mg [ppm] | 70 | |
| 0.20% | | | |
| propane-1,2-diol | P [ppm] | 255 | |
| as standard | FFA [%] | — | |
| with addition of water | Gum [%] | 4.6 | |
| 0.20% | Ca [ppm] | 140 | 95.2 |
| propane-1,2-diol | Mg [ppm] | 68 | |
| 5 minutes before addition of | P [ppm] | 270 | |
| water | FFA [%] | 0.3 | |
| | Gum [%] | 4 | |
| 0.20% | Ca [ppm] | 108 | 95.2 |
| propane-1,2-diol | Mg [ppm] | 53 | |
| 30 minutes after addition of | P [ppm] | 210 | |
| water | FFA [%] | 0.3 | |
| | Gum [%] | 4.5 | |
| 0.20% | Ca [ppm] | 145 | 95.4 |
| propane-1,2-diol | Mg [ppm] | 69 | |
| 5 minutes before end of | P [ppm] | 290 | |
| reaction | FFA [%] | 0.35 | |
| | Gum [%] | 4.5 | |

For the heptane-1,7-diol solubilizer, it is found that it is best used together with the water directly at the start of the lecithin production for the achievement of a maximum oil yield. For propane-1,2-diol, the dosage of the additive shortly before the end of the reaction is the most favorable. The results suggest that the most favorable time of dosage is dependent on the chemical structure of the solubilizer.

### Example 5

Partial Neutralization in the Crude Oil at 48° C. without Enzyme, Separation at 80° C.—Experiments with Soybean Oil and Rapeseed Oil (Reaction Variant 3)

In this reaction variant, conditions as typically established in enzymatic oil degumming were established, but no enzyme was metered in. These measurements serve as reference for the reaction mixtures examined in later examples for the enzymatic oil degumming. The influence of the additives on the starting situation for the enzymatic oil degumming can be examined here. In addition, the results document the positive influence of the additives of the invention in the case of partial neutralization of the citric acid.

The following table shows the characterization data of the oils used:

TABLE 12
Characterization data of the oils used in example 5

| | Crude soybean oil | Crude rapeseed oil |
|---|---|---|
| Ca content [ppm] | 172 | 230 |
| Mg content [ppm] | 129 | 74 |
| P content [ppm] | 800 | 1150 |
| FFA content [%] | 0.99 | 1.2 |

530 g of crude vegetable oil (crude soybean oil and rapeseed oil), after the reactor pot had been weighed, were introduced into a Duran reactor, heated to 48° C. and stirred at a stirrer speed of 150 rpm. Thereafter, 1000 ppm of 50% citric acid (depending on the calcium and magnesium values and on the phosphorus value) were metered in and the mixture was stirred for a further 15 minutes. This was followed by partial neutralization with 4 molar (16%) sodium hydroxide solution to pH 4. The amount of alkali required for the purpose had been determined beforehand in a titration curve with citric acid. After an additional reaction time of 10 minutes, the water (comparative experiments) or the water with the added solubilizer (inventive procedure) was metered. In the case of the degumming of soybean oil, 2.5% total water were employed here, and in the case of rapeseed oil 3% total water. The amount of water added at this stage corresponded to the total water minus the amount of water added with acid and alkali, and 0.2% solubilizer.

If the additives of the invention were used, these (0.2% by weight of additive in each case, based on the total amount of oil) were mixed with the water in a beaker and subsequently added to the reaction mixture via a funnel. The reaction time was 60 minutes. For analyses, samples were taken from the reaction mixture after 10, 30 and 60 minutes.

Finally, the reaction mixture, for preparation for the separation, was heated up to 80° C., the stirrer was switched off and the reaction mixture was left to stand for 5 minutes. Thereafter, the oil (reaction mixture) was transferred into a centrifuge cup and heated in a drying cabinet at 80° C. for another 15 minutes, then centrifuged in a laboratory centrifuge at 4000 rpm for 10 minutes. Finally, the oil phase was emptied and, via the weighing of the centrifuge cup, the mass of heavy phase was determined.

TABLE 13
relating to example 5: Partial neutralization
of soybean oil after citric acid treatment:
Soybean oil

| | | | | | Oil |
|---|---|---|---|---|---|
| | | 10 | 30 | 60 | yield |
| Experiment | | min. | min. | min. | [%] |
| Partial neutralization | Ca [ppm] | 41 | 31 | 34 | 95.3 |
| without enzyme | Mg [ppm] | 24 | 16 | 15 | |
| (standard degumming) | P [ppm] | 160 | 95 | 90 | |
| | FFA [%] | 0.9 | — | 0.87 | |
| | Gum [%] | 3.5 | 4 | 4 | |
| 0.20% | Ca [ppm] | 43 | 24 | 25 | 95.6 |
| 1-octanol | Mg [ppm] | 30 | 14 | 14 | |
| | P [ppm] | 195 | 96 | 90 | |
| | FFA [%] | 0.87 | | 0.9 | |
| | Gum [%] | 3.3 | 4.2 | 4 | |
| 0.20% | Ca [ppm] | 37 | 30 | 33 | 95.7 |
| 1-heptanol | Mg [ppm] | 21 | 12 | 13 | |
| | P [ppm] | 140 | 73 | 72 | |
| | FFA [%] | | | | |
| | Gum [%] | 4.2 | 4.7 | 4.1 | |
| 0.20% | Ca [ppm] | 44 | 44 | 28 | 95.4 |
| 3-heptanol | Mg [ppm] | 29 | 29 | 11 | |
| | P [ppm] | 190 | 190 | 62 | |
| | FFA [%] | | | | |
| | Gum [%] | 3.3 | 4.7 | 4.9 | |
| 0.20% | Ca [ppm] | 46 | 34 | 34 | 95.5 |
| 1-hexanol | Mg [ppm] | 26 | 14 | 14 | |
| | P [ppm] | 180 | 87 | 87 | |
| | FFA [%] | — | — | — | |
| | Gum [%] | 3.5 | 4.5 | 4.3 | |
| 0.20% | Ca [ppm] | 34 | 32 | 33 | 95.3 |
| 3-hexanol | Mg [ppm] | 9.5 | 6.8 | 6.5 | |
| | P [ppm] | 56 | 40 | 37 | |
| | FFA [%] | — | — | — | |
| | Gum [%] | 4.5 | 4 | 4 | |
| 0.20% | Ca [ppm] | 32 | 22 | 24 | 95.6 |
| 1-pentanol | Mg [ppm] | 22 | 12 | 13 | |
| | P [ppm] | 152 | 83 | 83 | |
| | FFA [%] | 0.86 | — | 0.92 | |
| | Gum [%] | 3.9 | 4.5 | 3.7 | |
| 0.20% | Ca [ppm] | 33 | 27 | 30 | 95.7 |
| 3-pentanol | Mg [ppm] | 21 | 13 | 14 | |
| | P [ppm] | 148 | 83 | 83 | |
| | FFA [%] | 0.84 | — | 0.9 | |
| | Gum [%] | 4 | 4.5 | 4 | |
| 0.20% | Ca [ppm] | 20 | 18 | 18 | 96.4 |
| heptane-1,7-diol | Mg [ppm] | 8.2 | 6.5 | 6.2 | |
| | P [ppm] | 53 | 44 | 40 | |
| | FFA [%] | — | — | — | |
| | Gum [%] | 4 | 4 | 4.3 | |
| 0.20% | Ca [ppm] | 24 | 23 | 23 | 96.0 |
| 2-methylpentane-2,4- | Mg [ppm] | 12 | 9.8 | 8.4 | |
| diol | P [ppm] | 82 | 65 | 51 | |
| | FFA [%] | — | — | — | |
| | Gum [%] | 4.7 | 4.2 | 4.3 | |
| 0.20% | Ca [ppm] | 68 | 40 | 51 | 95.6 |
| hexane-1,6-diol | Mg [ppm] | 29 | 9.8 | 14 | |
| | P [ppm] | 190 | 45 | 74 | |
| | FFA [%] | — | — | — | |
| | Gum [%] | 4.5 | 4.5 | 4.2 | |
| 0.20% | Ca [ppm] | 29 | 21 | 21 | 96.4 |
| hexane-1,2-diol | Mg [ppm] | 11 | 6.4 | 6.3 | |
| | P [ppm] | 64 | 42 | 41 | |
| | FFA [%] | — | — | — | |
| | Gum [%] | 4.5 | 4.5 | 4.5 | |
| 0.20% | Ca [ppm] | 40 | 30 | 30 | 96.8 |
| hexane-2,5-diol | Mg [ppm] | 18 | 11 | 9.8 | |
| | P [ppm] | 110 | 59 | 56 | |
| | FFA [%] | — | — | — | |
| | Gum [%] | 4 | 4 | 4 | |
| 0.20% | Ca [ppm] | 18 | 16 | 16 | 96.1 |
| 2,2-dimethylpropane- | Mg [ppm] | 9.3 | 7.3 | 6.3 | |
| 1,3-diol | P [ppm] | 63 | 46 | 39 | |
| | FFA [%] | 0.94 | — | 0.92 | |
| | Gum [%] | 4 | 4 | 4 | |
| 0.20% | Ca [ppm] | 37 | 28 | 29 | 96.1 |
| butane-2,3-diol | Mg [ppm] | 19 | 13 | 12 | |
| | P [ppm] | 125 | 78 | 69 | |
| | FFA [%] | | | | |
| | Gum [%] | 4.5 | 4.4 | 4.3 | |
| 0.20% | Ca [ppm] | 38 | 33 | 36 | 95.8 |
| propane-1,2-diol | Mg [ppm] | 21 | 14 | 14 | |
| | P [ppm] | 135 | 79 | 75 | |
| | FFA [%] | 0.88 | — | 0.91 | |
| | Gum [%] | 4 | 4.3 | 4.3 | |

The measurement results for soybean oil in the above table show that the solubilizers of the invention lead to an increase in the oil yield under these reaction conditions. At the concentration of 0.2% by weight used, it is possible to achieve increases in oil yield of up to 1.5%. The additives also contribute to a reduction in the P content in the oil and to a reduction in the divalent Mg²⁺ and Ca²⁺ ions in the oil.

TABLE 14
example 5: Partial neutralization of rapeseed
oil after citric acid treatment
Rapeseed oil

| | | | | | Oil |
|---|---|---|---|---|---|
| | | 10 | 30 | 60 | yield |
| Experiment | | min. | min. | min. | [%] |
| Partial neutralization | Ca [ppm] | 9.4 | 6.6 | 4.2 | 93.8 |
| (standard degumming | Mg [ppm] | 1.9 | 1.4 | 1 | |
| without additive) | P [ppm] | 18 | 14 | 13 | |
| | FFA [%] | 0.93 | — | 0.97 | |
| | Gum [%] | 6 | 6 | 5.7 | |
| 0.20% | Ca [ppm] | 10 | 6.8 | 4 | 94.0 |
| 1-octanol | Mg [ppm] | 1.7 | 1.2 | 0.7 | |
| | P [ppm] | 16 | 14 | 12 | |
| | FFA [%] | 0.97 | | 0.96 | |
| | Gum [%] | 6.5 | 6 | 6.0 | |
| 0.20% | Ca [ppm] | 7.1 | 5 | 2.7 | 93.9 |
| 3-heptanol | Mg [ppm] | 1.3 | 1.1 | 0.9 | |
| | P [ppm] | 14 | 11 | 12 | |
| | FFA [%] | | | | |
| | Gum [%] | 6 | 6 | 5.5 | |
| 0.20% | Ca [ppm] | 14 | 9.3 | 6.8 | 95.1 |
| heptane-1,7-diol | Mg [ppm] | 2.4 | 1.9 | 1.4 | |
| | P [ppm] | 25 | 21 | 17 | |
| | FFA [%] | 0.98 | — | 1.01 | |
| | Gum [%] | 5.5 | 5 | 5.2 | |
| 0.20% | Ca [ppm] | 13 | 8.8 | 5.2 | 93.9 |
| 2-methylpentane-2,4- | Mg [ppm] | 2.2 | 1.5 | 1.1 | |
| diol | P [ppm] | 23 | 19 | 15 | |
| | FFA [%] | 0.97 | — | 1.00 | |
| | Gum [%] | 6 | 5.7 | 5.2 | |
| 0.20% | Ca [ppm] | 12 | 7.9 | 4.4 | 93.8 |
| propane-1,2-diol | Mg [ppm] | 2.2 | 1.7 | 1.3 | |
| | P [ppm] | 20 | 17 | 16 | |
| | FFA [%] | 0.94 | — | 0.96 | |
| | Gum [%] | 6 | 5.5 | 5.5 | |

The table shows that it is possible with individual additives of the invention to increase the oil yield of the invention in the degumming of rapeseed oil under these conditions as well. Heptane-1,7-diol is especially suitable for this purpose.

### Example 6: Partial Neutralization in Crude Oil at 48° C. without Enzyme, Separation at 80° C. with Varied Times of Addition for Solubilizer Addition (Reaction Variant 3)

Within the scope of this example, the influence of the time of dosage on the oil degumming in partial neutralization in crude oil is examined, as shown in example 5. In order to assure the comparability of results, the same soybean oil was used as for example 5:

TABLE 15
Characterization data of the soybean oil used in example 6

| | Measurement |
|---|---|
| Ca content [ppm] | 172 |
| Mg content [ppm] | 129 |
| P content [ppm] | 800 |
| FFA content [%] | 0.99 |

For the performance of the degumming of the soybean oil, the procedure was exactly as described in example 5. Merely different times of dosage were chosen for the additives of the invention:

Variant 4a: 0.2% solubilizer addition 5 minutes prior to the addition of acid
Variant 4b: 0.2% solubilizer addition together with the addition of acid
Variant 4c: 0.2% solubilizer addition 7 minutes after the addition of acid
Variant 4d: 0.2% solubilizer addition together with the addition of alkali
Variant 4e: 0.2% solubilizer addition 5 minutes after the addition of alkali
Variant 4f: 0.2% solubilizer addition 30 minutes after the addition of water
Variant 4g: 0.2% solubilizer addition 5 minutes before the end of the reaction

TABLE 16
relating to example 6 partial neutralization of soybean
oil and heptane-1,7-diol and propane-1,2-diol as additive
Soybean oil

| | | | | | Oil |
|---|---|---|---|---|---|
| | | 10 | 30 | 60 | yield |
| Experiment | | min. | min. | min. | [%] |
| Partial neutralization | Ca [ppm] | 41 | 31 | 34 | 95.3 |
| without enzyme | Mg [ppm] | 24 | 16 | 15 | |
| (standard degumming) | P [ppm] | 160 | 95 | 90 | |
| | FFA [%] | 0.9 | — | 0.87 | |
| | Gum [%] | 3.5 | 4 | 4 | |
| 0.20% | Ca [ppm] | 20 | 18 | 18 | 96.4 |
| heptane-1,7-diol | Mg [ppm] | 8.2 | 6.5 | 6.2 | |
| as standard | P [ppm] | 53 | 44 | 40 | |
| with addition of water | FFA [%] | — | — | — | |
| | Gum [%] | 4 | 4 | 4.3 | |
| 0.20% | Ca [ppm] | 20 | 15 | 15 | 96.2 |
| heptane-1,7-diol | Mg [ppm] | 13 | 7.8 | 6.7 | |
| 5 minutes before | P [ppm] | 93 | 52 | 45 | |
| addition of acid | FFA [%] | 1.04 | | 1.01 | |
| (variant a) | Gum [%] | 3.5 | 4 | 4.1 | |
| 0.20% | Ca [ppm] | 44 | 44 | 42 | 96 |
| heptane-1,7-diol | Mg [ppm] | 17 | 15 | 14 | |
| with addition of acid | P [ppm] | 92 | 80 | 74 | |
| (variant b) | FFA [%] | 0.99 | | 1.02 | |
| | Gum [%] | 4.1 | 4.4 | 4.8 | |
| 0.20% | Ca [ppm] | 46 | 46 | 43 | 96.4 |
| heptane-1,7-diol | Mg [ppm] | 18 | 17 | 14 | |
| 7 minutes after | P [ppm] | 92 | 83 | 75 | |
| addition of acid | FFA [%] | 0.96 | | 1.05 | |
| (variant c) | Gum [%] | 4.2 | 4.6 | 4.4 | |
| 0.20% | Ca [ppm] | 30 | 25 | 25 | 95.9 |
| heptane-1,7-diol | Mg [ppm] | 15 | 10 | 9.3 | |
| with addition of | P [ppm] | 98 | 60 | 52 | |
| alkali (variant d) | FFA [%] | 1.01 | | 1.01 | |
| | Gum [%] | 3.9 | 4 | 4 | |
| 0.20% | Ca [ppm] | 42 | 31 | 30 | 96.0 |
| heptane-1,7-diol | Mg [ppm] | 26 | 14 | 11 | |
| 5 minutes after | P [ppm] | 165 | 80 | 60 | |
| addition of alkali | FFA [%] | 1.01 | | 0.95 | |
| (variant e) | Gum [%] | 3 | 4 | 4 | |
| 0.20% | Ca [ppm] | 57 | 28 | 33 | 96.1 |
| heptane-1,7-diol | Mg [ppm] | 41 | 16 | 17 | |
| 30 minutes after | P [ppm] | 280 | 103 | 105 | |
| addition of water | FFA [%] | 1.01 | | 0.97 | |
| (variant f) | Gum [%] | 3.5 | 4 | 4 | |
| 0.20% | Ca [ppm] | 46 | 23 | 19 | 96.0 |
| heptane-1,7-diol | Mg [ppm] | 33 | 14 | 13 | |
| 5 minutes before end | P [ppm] | 230 | 95 | 89 | |
| of reaction (variant | FFA [%] | 0.94 | | 1 | |
| g) | Gum [%] | 3.5 | 4 | 4 | |
| 0.20% | Ca [ppm] | 38 | 33 | 36 | 95.8 |
| propane-1,2-diol | Mg [ppm] | 21 | 14 | 14 | |
| as standard | P [ppm] | 135 | 79 | 75 | |
| with addition of water | FFA [%] | 0.88 | — | 0.91 | |
| | Gum [%] | 4 | 4.3 | 4.3 | |
| 0.20% | Ca [ppm] | 36 | 21 | 19 | 96.0 |
| propane-1,2-diol | Mg [ppm] | 27 | 14 | 8.9 | |
| 5 minutes before | P [ppm] | 200 | 100 | 56 | |
| addition of acid | FFA [%] | 0.92 | | 0.89 | |
| (variant a) | Gum [%] | 3.5 | 4.4 | 4.4 | |
| 0.20% | Ca [ppm] | 35 | 24 | 23 | 95.7 |
| propane-1,2-diol | Mg [ppm] | 26 | 16 | 11 | |
| with addition of acid | P [ppm] | 185 | 110 | 60 | |
| (variant b) | FFA [%] | 0.99 | | 0.91 | |
| | Gum [%] | 3.5 | 4.5 | 4.5 | |
| 0.20% | Ca [ppm] | 34 | 36 | 26 | 95.9 |
| propane-1,2-diol | Mg [ppm] | 24 | 18 | 11 | |
| 7 minutes after | P [ppm] | 165 | 110 | 65 | |
| addition of acid | FFA [%] | 0.93 | | 0.89 | |
| (variant c) | Gum [%] | 3 | 4.5 | 4.5 | |
| 0.20% | Ca [ppm] | 47 | 25 | 35 | 95.9 |
| propane-1,2-diol | Mg [ppm] | 29 | 15 | 14 | |
| with addition of | P [ppm] | 200 | 103 | 78 | |
| alkali (variant d) | FFA [%] | 0.96 | | 0.88 | |
| | Gum [%] | 3.5 | 4.3 | 4.2 | |
| 0.20% | Ca [ppm] | 26 | 25 | 27 | 95.9 |
| propane-1,2-diol | Mg [ppm] | 18 | 12 | 12 | |
| 5 minutes after | P [ppm] | 130 | 78 | 70 | |
| addition of alkali | FFA [%] | 0.97 | 0.96 | 0.95 | |
| (variant e) | Gum [%] | 4 | 4.5 | 4 | |
| 0.20% | Ca [ppm] | 33 | 23 | 28 | 96.2 |
| propane-1,2-diol | Mg [ppm] | 24 | 13 | 13 | |
| 30 minutes after | P [ppm] | 168 | 83 | 82 | |
| addition of water | FFA [%] | 0.9 | 0.93 | 0.95 | |
| (variant f) | Gum [%] | 4 | 4.8 | 4 | |
| 0.20% | Ca [ppm] | 36 | 25 | 28 | 96.1 |
| propane-1,2-diol | Mg [ppm] | 26 | 14 | 13 | |
| 5 minutes before end | P [ppm] | 200 | 88 | 77 | |
| of reaction (variant | FFA [%] | 1 | 0.94 | 1.02 | |
| g) | Gum [%] | 3.5 | 4 | 4.3 | |

In the case of heptane-1,7-diol as additive, both with regard to the oil yield and with regard to the lowering of the P and ion values, it is found that dosage with the water or the acid is the most favorable.

### Example 7: Enzymatic Degumming with Phospholipase A1 Partial Neutralization in Crude Oil at 48° C. with Enzyme, Separation at 80° C. (Reaction Variant 6)

Within the scope of this example, the influence of the solubilizers of the invention on the enzymatic oil degumming with phospholipase A1 is examined. In order to be able to separate the effects of enzyme and additives, the measurement data should be compared with the results in example 5 (identical experimental conditions, but working without addition of enzyme).

The following table shows the characterization data of oils used:

TABLE 17
Characterization data of the oils used in example
7 (identical oil to examples 5 and 6)

| | Crude soybean oil | Crude rapeseed oil |
|---|---|---|
| Ca content [ppm] | 172 | 230 |
| Mg content [ppm] | 129 | 74 |
| P content [ppm] | 800 | 1150 |
| FFA content [%] | 0.99 | 1.2 |

For these studies, the procedure was analogous to the partial neutralization described for example 5 (without enzyme); in other words, the same conditions as in example 5 were chosen, but only one enzyme was added. The enzyme used was PLAT in an amount of 0.5 U/g of oil.

The solubilizers were used in a concentration of 0.2% by weight based on the oil. The enzyme dosage followed the partial neutralization with the addition of water (and solubilizer in the inventive batches). As in example 5, 2.5% total water was used in the case of soybean oil and 3% total water in the case of rapeseed oil, minus the amount of water added with acid and alkali, and 0.2% solubilizer based on the amount of oil used.

The solubilizer and enzyme are first mixed with the water in a beaker and then added to the reaction mixture through a funnel. The further procedure thereafter was as described in example 5.

TABLE 18
for example 7: Enzymatic degumming of soybean oil
Soybean oil

| | | | | | Oil |
|---|---|---|---|---|---|
| | | 10 | 30 | 60 | yield |
| Experiment | | min. | min. | min. | [%] |
| Partial neutralization | Ca [ppm] | 16 | 15 | 9 | 96.0 |
| with 0.5 U/g PLA1 | Mg [ppm] | 8.7 | 7.2 | 4.3 | |
| (standard degumming) | P [ppm] | 57 | 44 | 24 | |
| | FFA [%] | — | | 0.95 | |
| | Gum [%] | 5.1 | 4.5 | 4 | |
| 0.20% | Ca [ppm] | 10 | 10 | 7 | 95.9 |
| 1-octanol + | Mg [ppm] | 6.3 | 5.5 | 3.4 | |
| 0.5 U/g PLA1 | P [ppm] | 37 | 30 | 16 | |
| | FFA [%] | 0.82 | | 0.96 | |
| | Gum [%] | 5.8 | 4.5 | 4.5 | |
| 0.20% | Ca [ppm] | 18 | 18 | 8.2 | 96.2 |
| 1-heptanol + | Mg [ppm] | 9.2 | 7.4 | 3.7 | |
| 0.5 U/g PLA1 | P [ppm] | 54 | 38 | 18 | |
| | FFA [%] | 0.91 | | 1.08 | |
| | Gum [%] | 5.4 | 4.5 | 4 | |
| 0.20% | Ca [ppm] | 27 | 22 | 22 | 96.3 |
| 3-heptanol + | Mg [ppm] | 12 | 8.6 | 8.1 | |
| 0.5 U/g PLA1 | P [ppm] | 58 | 39 | 37 | |
| | FFA [%] | 0.92 | | 1.09 | |
| | Gum [%] | 5.6 | 4.5 | 3.5 | |
| 0.20% | Ca [ppm] | 20 | 20 | 16 | 96.3 |
| 1-hexanol + | Mg [ppm] | 7.9 | 7.5 | 5.7 | |
| 0.5 U/g PLA1 | P [ppm] | 48 | 42 | 28 | |
| | FFA [%] | 0.8 | — | 1.03 | |
| | Gum [%] | 4.2 | 4.5 | 4 | |
| 0.20% | Ca [ppm] | 28 | 48 | 34 | 96.1 |
| 3-hexanol + | Mg [ppm] | 7.9 | 14 | 6.3 | |
| 0.5 U/g PLA1 | P [ppm] | 41 | 85 | 29 | |
| | FFA [%] | 0.95 | — | 0.9 | |
| | Gum [%] | 4 | 4.5 | 3.5 | |
| 0.20% | Ca [ppm] | 20 | 16 | 12 | 96.2 |
| 1-pentanol + | Mg [ppm] | 9.4 | 8.3 | 5.4 | |
| 0.5 U/g PLA1 | P [ppm] | 56 | 42 | 25 | |
| | FFA [%] | 0.87 | — | 1.01 | |
| | Gum [%] | 5.3 | 4.5 | 3.8 | |
| 0.20% | Ca [ppm] | 21 | 18 | 15 | 96.2 |
| 3-pentanol + | Mg [ppm] | 11 | 8.8 | 6.6 | |
| 0.5 U/g PLA1 | P [ppm] | 61 | 46 | 33 | |
| | FFA [%] | 0.85 | — | 1.06 | |
| | Gum [%] | 5 | 4 | 3.7 | |
| 0.20% | Ca [ppm] | 12 | 15 | 14 | 96.4 |
| heptane-1,7-diol + | Mg [ppm] | 5.7 | 5.9 | 5.8 | |
| 0.5 U/g PLA1 | P [ppm] | 36 | 39 | 36 | |
| | FFA [%] | 0.97 | — | 1.09 | |
| | Gum [%] | 4 | 3.7 | 3.5 | |
| 0.20% | Ca [ppm] | 21 | 11 | 17 | 96.5 |
| 2-methylpentane-2,4- | Mg [ppm] | 7.9 | 4 | 5.4 | |
| diol + 0.5 U/g PLA1 | P [ppm] | 45 | 21 | 27 | |
| | FFA [%] | 0.9 | — | 1.1 | |
| | Gum [%] | 4.7 | 4 | 3.5 | |
| 0.20% | Ca [ppm] | 44 | 43 | 33 | 96.2 |
| hexane-1,6-diol + | Mg [ppm] | 11 | 9.4 | 7.3 | |
| 0.5 U/g PLA1 | P [ppm] | 52 | 43 | 28 | |
| | FFA [%] | 0.85 | — | 1.01 | |
| | Gum [%] | 5.7 | 3.7 | 3.7 | |
| 0.20% | Ca [ppm] | 16 | 14 | 11 | 96.5 |
| hexane-1,2-diol + | Mg [ppm] | 6.3 | 5.5 | 3.9 | |
| 0.5 U/g PLA1 | P [ppm] | 38 | 34 | 24 | |
| | FFA [%] | 0.97 | — | 1.15 | |
| | Gum [%] | 4 | 3.9 | 3 | |
| 0.20% | Ca [ppm] | 12 | 24 | 22 | 96.2 |
| hexane-2,5-diol + | Mg [ppm] | 6.8 | 8.2 | 7.5 | |
| 0.5 U/g PLA1 | P [ppm] | 33 | 43 | 40 | |
| | FFA [%] | 0.99 | — | 1.09 | |
| | Gum [%] | 4 | 3.5 | 3.2 | |
| 0.20% | Ca [ppm] | 4.9 | 11 | 11 | 96.2 |
| 2,2-dimethylpropane- | Mg [ppm] | 2.6 | 5.1 | 4.9 | |
| 1,3-diol + 0.5 U/g PLA1 | P [ppm] | 15 | 29 | 27 | |
| | FFA [%] | 0.96 | — | 0.91 | |
| | Gum [%] | 4.3 | 4 | 3.5 | |
| 0.20% | Ca [ppm] | 8.7 | 5.1 | 10 | 96.3 |
| butane-2,3-diol + | Mg [ppm] | 5.1 | 2.5 | 4.3 | |
| 0.5 U/g PLA1 | P [ppm] | 28 | 14 | 26 | |
| | FFA [%] | | | | |
| | Gum [%] | 4 | 4 | 3.7 | |
| 0.20% | Ca [ppm] | 16 | 7.7 | 13 | 96.3 |
| propane-1,2-diol + | Mg [ppm] | 6.9 | 3.4 | 5.6 | |
| 0.5 U/g PLA1 | P [ppm] | 39 | 18 | 31 | |
| | FFA [%] | — | | 1.08 | |
| | Gum [%] | 4.3 | 4 | 3.5 | |

The results show that a series of additives can increase the oil yield in enzymatic soybean oil degumming with phospholipase 1, and the chosen dosage of 0.2% gives the greatest increase in the oil yield of 0.5% in the case of use of 2-methylpentane-2,4-diol and hexane-1,2-diol.

Some additives, especially 1-octanol, 3-heptanol, 2,3-dimethylpropane-1,3-diol, butane-2,3-diol and propane-1,2-diol also lead to acceleration of the reaction compared to the enzymatic degumming without additives, recognizable especially from the P values of the oil after 10 minutes. One example of this is the additive 2,2-dimethylpropane-1,3-diol, the use of which lowers the P value after 10 minutes to 15 ppm compared to 57 ppm of P in the case of enzymatic degumming without additive.

TABLE 19
relating to example 7: Enzymatic degumming of
rapeseed oil without and with addition of solubilizers
Rapeseed oil

| | | | | | Oil |
|---|---|---|---|---|---|
| | | 10 | 30 | 60 | yield |
| Experiment | | min. | miru | min. | [%] |
| Partial neutralization | Ca [ppm] | 5.6 | 5.1 | 4 | 94.5 |
| with 0.5 U/g PLA1 | Mg [ppm] | 1.4 | 1.3 | 0.9 | |
| (standard degumming) | P [ppm] | 12 | 13 | 7 | |
| | FFA [%] | 1.44 | — | 1.66 | |
| | Gum [%] | 5.3 | 5.3 | 5.0 | |
| 0.20% | Ca [ppm] | 15 | 11 | 9.6 | 94.4 |
| 1-octanol + | Mg [ppm] | 2.6 | 1.8 | 1.4 | |
| 0.5 U/g PLA1 | P [ppm] | 19 | 15 | 11 | |
| | FFA [%] | 1.22 | — | 1.37 | |
| | Gum [%] | 5.5 | 5 | 4.7 | |
| 0.20% | Ca [ppm] | 13 | 10 | 8.2 | 94.5 |
| 3-heptanol + | Mg [ppm] | 2.1 | 1.6 | 1.2 | |
| 0.5 U/g PLA1 | P [ppm] | 18 | 14 | 10 | |
| | FFA [%] | 1.18 | — | 1.53 | |
| | Gum [%] | 5.5 | 5.3 | 5.0 | |
| 0.20% | Ca [ppm] | 6.8 | 4.9 | 4.4 | 94.5 |
| heptane-1,7-diol + | Mg [ppm] | 1.3 | 1.3 | 1 | |
| 0.5 U/g PLA1 | P [ppm] | 9.7 | 12 | 7.5 | |
| | FFA [%] | 1.34 | — | 1.53 | |
| | Gum [%] | 5 | 5.4 | 5 | |
| 0.20% | Ca [ppm] | 6.3 | 4.9 | 4.2 | 94.6 |
| 2-methylpentane-2,4- | Mg [ppm] | 1.2 | 1 | 0.9 | |
| diol + 0.5 U/g PLA1 | P [ppm] | 7.7 | 7.2 | 7 | |
| | FFA [%] | 1.45 | — | 1.68 | |
| | Gum [%] | 5.4 | 5.4 | 5.3 | |
| 0.20% | Ca [ppm] | 5.6 | 4.5 | 4.1 | 94.4 |
| propane-1,2-diol + | Mg [ppm] | 1.2 | 0.9 | 1.1 | |
| 0.5 U/g PLA1 | P [ppm] | 9.1 | 6.3 | 7.2 | |
| | FFA [%] | 1.32 | — | 1.69 | |
| | Gum [%] | 5.5 | 5.5 | 5.1 | |

It is found that the additives have a different effect on the enzymatic degumming of rapeseed oil with PLAT than soybean oil. It is also possible to identify additives of the invention that exhibit positive effects with regard to the reduction in the P values and ion values. This is the case especially with the use of 2-methylpentane-2,4-diol and propane-1,2-diol.

### Example 8 Partial Neutralization and Enzymatic Degumming with Addition of Polyglycols

Using the reaction conditions in example 7, the effect of a polyglycol on citric acid degumming with partial neutralization and enzymatic degumming was examined (reaction variants 3 and 4). For this purpose, a polyglycol B11/50 was used. This is an ethylene oxide-propylene oxide monobutyl ether wherein the ethylene oxide and propylene oxide groups are randomly distributed (mean molar mass: 1300 g/mol and HLB value: 9.58). The compound was purchased from Clariant Produkte (Deutschland) GmbH in Gendorf.

For this purpose, a soybean oil with the following characterization data was used:

TABLE 20
Characterization data of the soybean oils used

| | Crude soybean oil |
|---|---|
| Ca content [ppm] | 172 |
| Mg content [ppm] | 129 |
| P content [ppm] | 800 |
| FFA content [%] | 0.99 |

For the experiments with the partial neutralization, the procedure was as described in example 5 (reaction variant 3); for the experiments on enzymatic degumming, the procedure was as described in example 7 (reaction variant 4). Only the addition of water was reduced from 2.5% to 2%. In the experiments with additive, 0.2% by weight of additive was used in each case, based on the oil.

The results of the studies are shown in the following table:

TABLE 21
Results of the degumming with ethylene oxide-propylene oxide
monobutyl ether as solubilizer in the partial neutralization of
crude soybean oil and in the enzymatic degumming of crude soybean oil
Soybean oil

| | | | | | Oil |
|---|---|---|---|---|---|
| | | 10 | 30 | 60 | yield |
| Experiment | | min. | min. | min. | [%] |
| Partial neutralization | Ca [ppm] | 29 | 23 | 21 | 95.7 |
| Reference measurement | Mg [ppm] | 20 | 15 | 13 | |
| | P [ppm] | 134 | 104 | 88 | |
| | FFA [%] | 0.81 | — | 0.94 | |
| | Gum [%] | 2.8 | 3.2 | 3.7 | |
| Partial neutralization | Ca [ppm] | 13 | 17 | 18 | 95.5 |
| with addition of | Mg [ppm] | 6.6 | 7 | 7 | |
| ethylene oxide- | P [ppm] | 42 | 43 | 40 | |
| propylene oxide | FFA [%] | 0.87 | — | 0.87 | |
| monobutyl ether | Gum [%] | 3.6 | 3.9 | 3.8 | |
| Partial neutralization + | Ca [ppm] | 14 | 13 | 8.8 | 96 |
| 0.5 U/g PLA1 | Mg [ppm] | 8 | 7.9 | 4.6 | |
| | P [ppm] | 48 | 45 | 21 | |
| | FFA [%] | 0.85 | | 0.93 | |
| | Gum [%] | 4.8 | 4.0 | 3.5 | |
| Partial neutralization + | Ca [ppm] | 11 | 5.9 | 4.6 | 96.4 |
| 0.5 U/g PLA1 | Mg [ppm] | 4.5 | 2.9 | 2.3 | |
| with addition of | P [ppm] | 27 | 19 | 15 | |
| ethylene oxide- | FFA [%] | 0.98 | — | 1.12 | |
| propylene oxide | Gum [%] | 4.1 | 3.2 | 2.9 | |
| monobutyl ether | | | | | |

The results indicate the effect of the polyglycol of the invention on the oil degumming. The partial neutralization without subsequent use of phospholipase does not increase the oil yield, but the values of P, Ca and Mg are distinctly reduced after 10 min and also after 30 min and 60 min of reaction time compared to the comparative measurement.

In the enzymatic oil degumming, the addition of the additive leads both to an increase in the oil yield and to significant lowering of the values for P, Ca and Mg in the oil compared to the comparative measurements without additives at 20 min, 30 min and 60 min. The rise in the FFA value with the additive documents the higher conversion of the phospholipase after 10 min and 60 min.

### Example 9 Aqueous Degumming with Citric Acid According to Reaction Variant 5

According to reaction variant 5, a crude soybean oil having the following starting contents was used: phosphorus 860 ppm, calcium 63 ppm, magnesium 60 ppm and a content of free fatty acids of 0.45%.

The crude oil was subjected to pre-conditioning with the aid of aqueous citric acid (1000 ppm) and then neutralized to pH 7 to 8 with aqueous sodium hydroxide solution (1 mol/L). Subsequently, various concentrations of propane-1,2-diol (0.05-0.2% by weight of propanediol) were added and stirring was continued. In a comparison, a sample without propane-1,2-diol (standard degumming) was stirred. The oil/water ratio (by weight) was 98.5:1.5. Samples were taken regularly (see table 22). At the end of the reaction, the gum phase was centrifuged off and the oil yield was determined via mass weighing.

The results are summarized in table 22. It can clearly be seen that an increasing concentration of propane-1,2-diol leads to a decrease in the calcium (Ca), magnesium (Mg) and phosphorus (P) ions. In the standard degumming of the soybean oil, the following ion values were achieved after a reaction time of one hour: Ca: 4.7 ppm; Mg: 3.7 ppm and P: 42 ppm. After a reaction time of one hour, the following ion values were achieved with 0.2% by weight propane-1,2-diol: Ca: 1.1 ppm; Mg: 0.69 ppm and P: 10 ppm. In addition, the oil yield increases with propane-1,2-diol from 95.5 to 95.8% by weight. The values were confirmed in repeat determinations. It was thus shown that the oil degumming is more effective and a higher oil yield is achieved as a result of the addition of propane-1,2-diol.

TABLE 22
Degumming with different concentrations of propane-
1,2-diol in comparison with standard degumming

| Test | | 10 min. | 60 min. | Oil yield [%] |
|---|---|---|---|---|
| Standard | Ca [ppm] | 7.6 | 4.7 | 95.5 |
| degumming | Mg [ppm] | 6.5 | 3.7 | |
| | P [ppm] | 77 | 42 | |
| | FFA [%] | 0.11 | 0.16 | |
| 0.05% | Ca [ppm] | 1.5 | 2.2 | 95.5 |
| propane-1,2- | Mg [ppm] | 1.2 | 1.8 | |
| diol | P [ppm] | 12 | 20 | |
| | FFA [%] | 0.07 | 0.15 | |
| 0.1% | Ca [ppm] | 1.6 | 2.2 | 95.6 |
| propane-1,2- | Mg [ppm] | 1.2 | 1.7 | |
| diol | P [ppm] | 12 | 18 | |
| | FFA [%] | 0.08 | 0.12 | |
| 0.2% | Ca [ppm] | 1.6 | 1.1 | 95.8 |
| propane-1,2- | Mg [ppm] | 1.2 | 0.9 | |
| diol | P [ppm] | 13 | 10 | |
| | FFA [%] | 0.11 | 0.15 | |

### Example 10: Enzymatic Degumming According to Reaction Variant 6

According to reaction variant 6, a crude soybean oil with the following starting contents was used: phosphorus 860 ppm, calcium 63 ppm, magnesium 60 ppm and a content of free fatty acids of 0.45%. The crude oil was subjected to pre-conditioning by means of aqueous citric acid (1000 ppm) and was then neutralized to pH 4-5 with aqueous sodium hydroxide solution (1 mol/L). A phospholipase A1 (PLA1) from Thermomyces lanuginosus and various concentrations of propane-1,2-diol (0.05 to 0.2% by weight) were then added according to reaction variant 6 and stirring was continued. As comparison, a sample without propane-1,2-diol (PLA1 standard degumming) was stirred. The oil/water ratio (weight) was 98.5:1.5. Samples were taken at regular intervals (see table 23). At the end of the reaction, the gum phase was removed by centrifugation and the oil yield was determined via mass weighing.

The results are summarized in table 23. It can clearly be seen that an increasing concentration of propane-1,2-diol leads to an increased oil yield and that the use, for example, of 0.2% by weight propane-1,2-diol+PLA1 permits a further increase by approximately 1% degummed soybean oil. The values were confirmed in repeat determinations. It was thus shown that the oil degumming is more effective and a higher oil yield is achieved as a result of the addition of propane-1,2-diol.

TABLE 23
Degumming with different concentrations of propane-1,2-
diol and PLA1 in comparison with PLA1 standard degumming

| Test | | 10 min. | 60 min. | Oil yield [%] |
|---|---|---|---|---|
| 0.5 U/g PLA1 | Ca [ppm] | 0.5 | 0.5 | 95.8 |
| standard | Mg [ppm] | 0.5 | 0.5 | |
| degumming | P [ppm] | 4.7 | 4.8 | |
| | FFA [%] | 0.15 | 0.31 | |
| | Gum [%] | 6.6 | 4.9 | |
| 0.025% | Ca [ppm] | 1 | 0.3 | 96.2 |
| propanediol + | Mg [ppm] | 0.9 | 0.3 | |
| 0.5 U/g | P [ppm] | 10 | 3.6 | |
| PLA1 | FFA [%] | 0.26 | 0.45 | |
| | Gum [%] | 3.9 | 2.8 | |
| 0.1% | Ca [ppm] | 0.9 | 1 | 96.6 |
| propanediol + | Mg [ppm] | 0.9 | 1 | |
| 0.5 U/g | P [ppm] | 7.5 | 9.6 | |
| PLA1 | FFA [%] | 0.20 | 0.32 | |
| | Gum [%] | 5.5 | 3.1 | |
| 0.2% | Ca [ppm] | 1 | 0.3 | 96.8 |
| propanediol + | Mg [ppm] | 0.9 | 0.3 | |
| 0.5 U/g | P [ppm] | 10 | 3.6 | |
| PLA1 | FFA [%] | 0.26 | 0.45 | |
| | Gum [%] | 3.9 | 2.8 | |

### Example 11: Aqueous Degumming of Soybean Oil on the Pilot Scale

Within the scope of the degumming processes in oil refining on the industrial scale, the separation of the oil phase and the water phase is typically conducted in a continuous process, using disk separators according to the prior art. In order to rework this process, a pilot plant experiment was conducted, in which a disk separator was used, as is typically also used for industrial degumming processes (“pilot scale”).

For mixing of the crude oil with the aqueous phase, a plant for oil degumming on the scale of 100 to 120 kg of vegetable oil with a stirrer system, temperature-controlled jacketed reactor and with an IST 060-TRA-10 1 pump system comparable to industry was utilized. For the separation, an OSC 4 separator from GEA-Westfalia (Oelde) was used. Such a separator is characterized in that the filling with oil and emptying of the cleaned oil is continuous, while the heavy phase (water with vegetable oil gum or lecithin) is discontinuous, and occurs whenever the separator is filled with gum.

For the experiments, a crude soybean oil was utilized, the characterization data of which are compiled in the following table:

TABLE 24
Characterization data of the crude soybean
oil used for the pilot plant experiments

| Content | Unit | Measurement |
|---|---|---|
| FFA | % | 0.69 |
| H₂O (water by | % | 0.06 |
| Karl Fischer - | | |
| DIN 51777) | | |
| P | ppm | 820 |
| Fe | ppm | 33 |
| Cu | ppm | <0.1 |
| Ca | ppm | 120 |
| Mg | ppm | 94 |
| Na | ppm | 2 |
| Al | ppm | 20 |

100-120 kg of the crude soybean oil in each case were first stirred with 2% by weight of water in the jacketed reactor at 60° C. for 60 minutes and then subjected to a phase separation with the disk separator. This experiment served as a comparative example for a standard separation. Analogously, in a second variant, 0.2% by weight (based on the mass of the oil used) of propane-1,2-diol, a solubilizer of the invention, was added to the water used for the degumming.

With regard to the separation, the following procedure was followed in both cases:

The volume flow rate was fixed at 100 L/h for all experiments, and the backpressure of the light phase to 3.5 bar. The time interval between the partial emptying operations was defined as a variable parameter.

After stirring time of 60 minutes with the aqueous phase, the mixture was heated to 80° C. for 10 min. Subsequently, the separator containing the reaction mixture was preheated until the first partial emptying, then set to the defined parameters (volume flow rate and backpressure) until the second partial emptying. During this time, the separated oil was run into a separate vessel and determined. The mass of the heavy phase was also determined separately. Then the second partial emptying was followed by the switch to the actual separation vessel.

Until the third partial emptying, the separator was again set to a constant separation. This includes the heating of the separator and the checking of the clarity of the light phase in the sightglass. Exactly within the interval after the third partial emptying until the fourth partial emptying, two samples were taken at the tap at the sightglass window from the clear-running liquid every minute. The first sample was for the determination of the ions; the second sample was a centrifuge tube sample for determination of the proportion of the heavy phase in the separated oil. For this purpose, centrifugation was effected at 4000 rpm in a laboratory centrifuge for four minutes after sampling.

Sampling and sample analysis always followed after the third partial emptying, in order to prevent effects of the startup of the separation on the results. The interval chosen for sampling was one minute.

According to the instrument manufacturer, a separation can be described as good when the proportion of heavy phase in the clear-running liquid (separated oil) is 0.1% to 0.2% or better. The two processes were repeated, resulting in no significant differences in the measurement data.

The results with purely aqueous degumming and with addition of 0.2% by weight of propane-1-2-diol to the oil are shown in the two tables below and the figures, which show the analysis data based on the separated oil as a function of the separation time.

TABLE 25
Separation of the soybean oil on the pilot
plant scale after the aqueous degumming

| | | | | | | | |
|---|---|---|---|---|---|---|---|
| | Heavy phase in | | | | | | |
| | clear-running | Ca [ppm] after | Mg [ppm] after | P [ppm] after | Ca [ppm] after | Mg [ppm] after | P [ppm] after |
| Time [min] | liquid [%] | separation | separation | separation | centrifugation | centrifugation | centrifugation |

3rd partial emptying

| | | | | | | | |
|---|---|---|---|---|---|---|---|
| 1 | 0.3 | 106 | 40 | 180 | 100 | 39 | 175 |
| 2 | 0.9 | 104 | 40 | 185 | 100 | 38 | 165 |
| 3 | 0.1 | 105 | 40 | 168 | 100 | 39 | 180 |
| 4 | 0.2 | 105 | 40 | 190 | 103 | 39 | 175 |
| 5 | 0.25 | 104 | 39 | 175 | 102 | 40 | 180 |
| 6 | 0.6 | 104 | 41 | 195 | 102 | 39 | 175 |
| 7 | 0.3 | 106 | 43 | 205 | 101 | 38 | 170 |
| 8 | 0.5 | 105 | 42 | 200 | 101 | 39 | 180 |
| 9 | 0.5 | 104 | 42 | 205 | 102 | 40 | 165 |
| 10 | 0.5 | 106 | 45 | 225 | 97 | 37 | 155 |

4th partial emptying

| | | | | | | | |
|---|---|---|---|---|---|---|---|
| 1 | 0.6 | 100 | 40 | 185 | 100 | 39 | 170 |

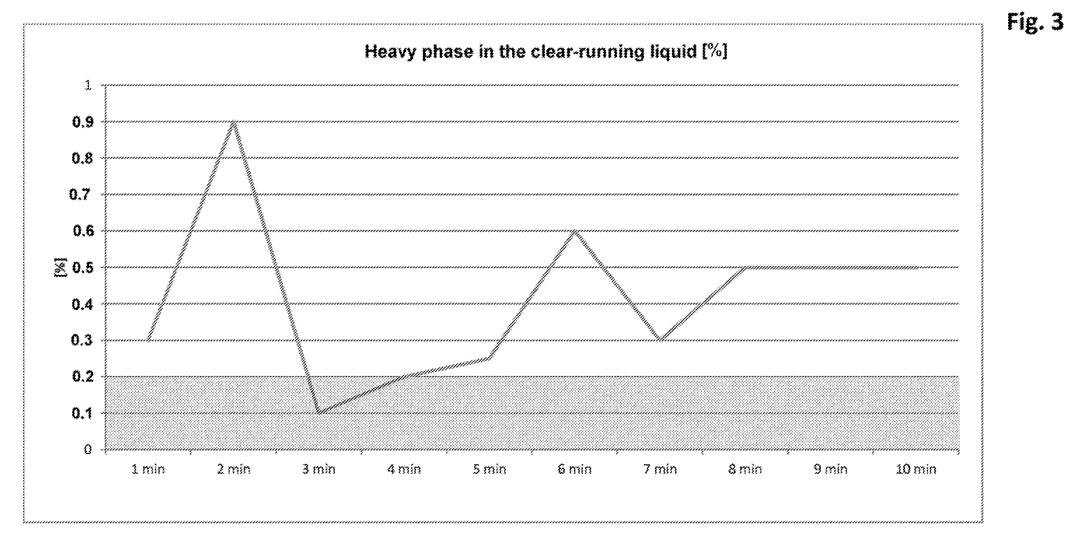

FIG. 3 shows the separation of the soybean oil on the pilot plant scale after the aqueous degumming (as per the data of table 25).

TABLE 26
Separation of the soybean oil on the pilot
plant scale after the aqueous degumming with addition
of 2.2% by weight of propane-1,2-diol

| | | | | | | | |
|---|---|---|---|---|---|---|---|
| | Heavy | | | | | | |
| | phase | | | | | | |
| | in | | | | | | |
| | clear- | Ca | Mg | P | | | |
| | running | [ppm] | [ppm] | [ppm] | Ca [ppm] | Mg [ppm] | P [ppm] |
| Time | liquid | after | after | after | after | after | after |
| [min] | [%] | separation | separation | separation | centrifugation | centrifugation | centrifugation |

3rd partial emptying

| | | | | | | | |
|---|---|---|---|---|---|---|---|
| 1 | 0.3 | 106 | 40 | 180 | 100 | 39 | 175 |
| 2 | 0.9 | 104 | 40 | 185 | 100 | 38 | 165 |
| 3 | 0.1 | 105 | 40 | 168 | 100 | 39 | 180 |
| 4 | 0.2 | 105 | 40 | 190 | 103 | 39 | 175 |
| 5 | 0.25 | 104 | 39 | 175 | 102 | 40 | 180 |
| 6 | 0.6 | 104 | 41 | 195 | 102 | 39 | 175 |
| 7 | 0.3 | 106 | 43 | 205 | 101 | 38 | 170 |
| 8 | 0.5 | 105 | 42 | 200 | 101 | 39 | 180 |
| 9 | 0.5 | 104 | 42 | 205 | 102 | 40 | 165 |
| 10 | 0.5 | 106 | 45 | 225 | 97 | 37 | 155 |

4th partial emptying

| | | | | | | | |
|---|---|---|---|---|---|---|---|
| 1 | 0.6 | 100 | 40 | 185 | 100 | 39 | 170 |

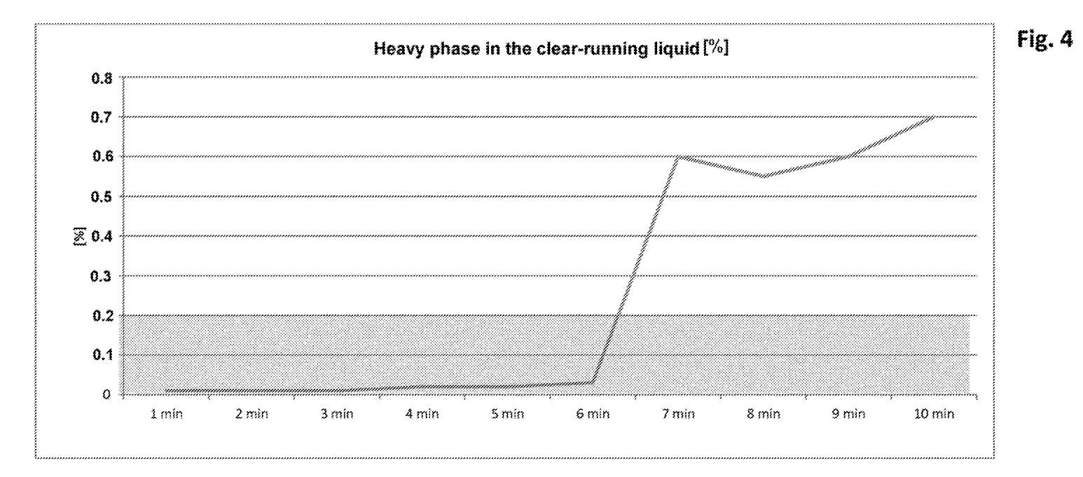

FIG. 4 shows the separation of the soybean oil on the pilot plant scale after the aqueous degumming with addition of 2.2% by weight of propane-1,2-diol (as per the data of table 26).

From the comparison of the content of the heavy phase of the separated oil (determined by the P content) as a function of the separation time, it is possible to make the following conclusions:

In the purely aqueous degumming, significant variations in the content of heavy phase occur from the start, which cannot be attributed to the separator becoming full. The upper limit with regard to the P content in the oil, defined on the industrial scale according to the separator manufacturer, is almost always exceeded after separation, and significant fluctuations occur.

The addition of propane-1,2-diol greatly improves the separation under the experimental conditions chosen. Within a period of up to 6 minutes, the proportion of the heavy phase in the separated oil remains very small and well below the upper limit of 0.2 weight. There is then a steep rise caused by the container for the gum in the separator becoming full. On the industrial scale, the separator would be emptied automatically here.

Indirectly, it is possible to infer a lower content of the gum in the oil and hence a higher oil yield through the use of propane-1,2-diol as additive from the profile of the content of heavy phase in the oil as a function of time, although exact quantification is not possible with these experimental data alone. If the first peak in the aqueous degumming is considered to be caused by process fluctuation because the content of heavy phase decreases below 0.2% by weight once again thereafter, the content of heavy phase remains above the limit of 0.2% from 4 minutes onward, meaning that the separator is then already filled with heavy phase. This situation occurs only after 7 minutes in the case of use of propane-1,2-diol.

What is claimed is:

1. A method of degumming triglyceride-containing compositions, comprising the steps of
(a) contacting a triglyceride-containing composition with at least one solubilizer;
(b) removing the gum phase from the triglyceride-containing composition.

2. The method as claimed in claim 1, wherein the at least one solubilizer has an HLB value of 5.5 to 13.5.

3. The method as claimed in claim 1, wherein the at least one solubilizer is selected from the group consisting of polyhydroxyl compounds, polyglycols, alcohols and mixtures thereof.

4. The method as claimed in claim 3, wherein the polyhydroxyl compounds have an asymmetric molecular structure.

5. The method as claimed in claim 1, wherein the at least one solubilizer is selected from the group consisting of propane-1,2-diol, propane-1,3-diol, butane-1,2-diol, methyl-glycol, methylpropane-1,3-diol, 1-octanol, 2,2-dimethylpropane-1,3-diol, butane-2,3-diol, butanol, ethanol, isopropanol, ethylene oxide-propylene oxide monobutyl ether, 1-pentanol, 3-pentanol, 2-methylpentane-2,4-diol, 1-hexanol, 3-hexanol, hexane-1,6-diol, hexane-2,5-diol, 1-heptanol, 3-heptanol, heptane-1,7-diol, sucrose esters, mono- and diacetyltartrates of monoglycerides, polyglycerol esters, sorbitan esters, polyoxyethylene sorbitan esters, polyethylene glycols, copolymers of ethylene oxide and propylene oxide units and mixtures thereof.

6. The method as claimed in claim 1, wherein separation of the gum phase from the triglyceride-containing composition in step (b) is preceded by addition of at least one enzyme to the triglyceride-containing composition.

7. The method as claimed in claim 6, wherein the at least one solubilizer is added before the at least one enzyme.

8. The method as claimed in claim 6, wherein the at least one enzyme is selected from the group consisting of phospholipid-cleaving enzymes, glycoside-cleaving enzymes and mixtures thereof.

9. The method as claimed claim 6, wherein the at least one enzyme has alpha- or beta-glucosidase activity.

10. The method as claimed in claim 6, wherein the at least one enzyme is selected from the group consisting of phospholipase A1, phospholipase A2, phospholipase C, acyltransferase, alpha-glucosidase, beta-glucosidase and mixtures thereof.

11. The method as claimed in claim 6, wherein the at least one enzyme comprises an amylase.

12. The method as claimed in claim 1, wherein the triglyceride-containing composition used is crude vegetable oil or pre-degummed vegetable oil.

13. The method as claimed in claim 1, wherein the triglyceride-containing composition is crude vegetable oil and, prior to the contacting in step (a), water and/or acid and/or alkali is added to the crude vegetable oil without conducting any removal step prior to the separation of the gum phase in step (b).

14-15. (canceled)
